(19) United States
(12) Patent Application Publication
(10) Pub. No.: US 2005/0035954 A1
(43) Pub. Date: Feb. 17, 2005

(54) Method and apparatus to facilitate automated transcription of NMR spectra into a textual report using a graphics tablet

(76) Inventor: Scott H. Allen, Raleigh, NC (US)

Correspondence Address: WITHROW & TERRANOVA, P.L.L.C., P.O. BOX 1287, CARY, NC, 27512, US

(21) Appl. No.: 10/918,265

(22) Filed: Aug. 13, 2004

Related U.S. Application Data
(60) Provisional application No. 60/494,453, filed on Aug. 13, 2003.

(51) Int. Cl. G09G 5/00

(52) U.S. Cl. 345/173

(57) ABSTRACT

A computer assisted method and apparatus for transcribing nuclear magnetic resonance (NMR) spectrum into a textual report. A graphics tablet containing a pointing device is used. A stacked plot containing a NMR spectrum is placed on the tablet and is calibrated. The user selects the location of the peaks within the signals in the spectrum using a pointing device. Selected peaks are communicated to application software executing on a computer coupled to the graphics tablet. The application software converts the coordinate data of the user-selected peaks into spectral positions that are used to generate the textual report. The user also controls the selection of the signal type as well as the number of protons contained in the signal. The application software determines the exact coordinates of the signal, but does not control selection, location or characterization data of the signal. This eliminates errors caused by totally computer-controlled text reporting systems.

### RELATED APPLICATION

This patent application claims priority to U.S. Provisional Patent Application No. 60/494,453 entitled “Method to facilitate the transcription of NMR spectra into textual reports using a graphics tablet,” filed on Aug. 13, 2003, which is incorporated herein by reference in its entirety.

### FIELD OF THE INVENTION

The present invention relates to a method and apparatus to transcribe information represented spatially in a printed nuclear magnetic resonance (NMR) spectrum in an automated fashion using a graphics tablet into a textual report.

### BACKGROUND OF THE INVENTION

NMR is one of the primary methods a chemist uses to identify and characterize organic compounds. The most common types of NMR experiments performed for this purposes are one-dimensional (¹H) NMR and one-dimensional carbon (¹³C) NMR. The data from these experiments is in the form of NMR spectrum. A chemist generally views the spectrum in the form of a plot, which is a selected region or regions of the spectrum that has been printed according to a set of plotting parameters. FIG. 1A illustrates an example of a regular plot of a nuclear magnetic resonance (NMR) spectrum 10 of the organic compound 3-(3-pyridyl)-1-propanol 12. A regular plot is a plot comprised of a single continuous region that shows the section of the spectrum containing all of the signals. The plot 10 is created by commercially and generally available NMR plotting software. For the example illustrated in FIG. 1A, the NMR software used to create the plot 10 is manufactured by Bruker and is well known to one of ordinary skill in the art.

In the example illustrated in FIG. 1A, the plot 10 contains parameter information on the left hand side. The name of the organic compound 14 is listed on the top left. Optional data parameters 16 and acquisition parameters 18 are listed by the plotting software as is well known. FIG. 1A does not show all possible acquisition parameters 18 that may be present due to size constraints, but these are well known to one of ordinary skill in the art. The solvent 20 used to dissolve the organic compound for the NMR experiment is listed among the acquisition parameters 18. Channel information 22 and other processing parameters 24 are also contained on the plot 10 as is well known.

The plot 10 is made up of a grid axis 26 along the bottom with the actual spectrum plotted on top. The grid axis 26 is listed in units of parts-per-million (ppm). It can be seen that a baseline 27 of the spectrum is generally offset vertically from the grid axis 26. A signal 28 is a region of the spectrum rising from the baseline 27. The spectral position of a signal 28 refers to its position relative to the grid axis 26. If one considers the grid axis 26 to be an x-axis, the spectral position can be considered to be the x-component of the position of the signal 28. Typically, the exact location of a signal 28 is not determined by visually judging where the signal 28 exists relative to the grid axis 26, but instead by reading the peak picked value (not shown in FIG. 1A) printed over the peak of a signal 28, which is provided on the plot 10 by the plotting software. Alternatively, peak picking information can be provided as a peak list as is well known. In FIG. 1A, there are eight specific signals shown 29, 30, 32, 34, 36, 38, 39, 40 that correspond to the organic compound 12.

FIG. 1B is another plot 10 of the same NMR spectrum 10 illustrated in FIG. 1A, except that the signals 28 shown are only in the region of approximately 8.50 ppm to 8.35 ppm to show more detail regarding the peaks in this range. Two signals 29, 30 are contained in the region of 8.50 ppm to 8.35 ppm on the plot 10. Signal 29, for example, is a doublet consisting of two peaks 29A, 29B. The peak picked values 31 for peaks 29A, 29B are contained at the top of the plot as 8.4534 ppm and 8.4491 ppm, respectively. The computer software that generated the plot 10 in FIG. 1B placed the peak picked values 31 over top the peaks as a record of exact peak locations to a chemist analyzing the plot 10.

If a chemist was using the plot 10 to transcribe the organic compound 12 into a textual report, the chemist would use the plot 10 in FIG. 1B to characterize signals 29, 30. For example, signal 29 is a doublet consisting of peaks 29A, 29B. The chemist can manually calculate the chemical shift of the doublet 29 by taking the average of the peak picked values 8.4534 ppm and 8.4491 ppm to arrive at a rounded chemical shift value of 8.45 ppm. Next, the chemist can manually calculate the coupling constant “J” for doublet 29 by taking the difference between the peak picked values 8.4534 ppm and 8.4491 ppm and multiplying this difference by the frequency of the plot 10, which is 500 MHz, to arrive at a rounded coupling constant value of 2.2 Hz. After the chemist calculates this information and determines the number of protons in signal 29 using an integral (not shown), the chemist describes signal 29 textually as “8.45 (d, J=2.2 Hz, 1 H),” which will be understood by other chemists. The exact order of the text in the NMR report can vary as is well known.

The advantage of a chemist determining a textual report of an NMR spectrum manually, like the example of signal 29 described above, is that the chemist has complete control of how the NMR spectrum is interpreted. Further, the chemist is using a printed copy of the plot 10 so that more detail can be seen in a smaller space so that the spectrum does not have to be expanded to the same degree that would be required on a computer screen. The disadvantage is time. As one can imagine, it can be a time consuming task for a chemist to manually calculate chemical shifts and coupling constants for the plot 10 to arrive at the textual report for an organic compound using the regular plot 10. For example, a chemist may only be able to manually analyze NMR spectrum plots 10 and formulate a corresponding textual report at a rate of four to five plots per hour depending upon the complexity of the NMR spectrum.

In an attempt to assist chemists in speeding up the process of deriving textual reports of NMR spectra, commercially available software has been developed to calculate spectral parameters via signal analysis methods. In this process, the user selects regions of the spectrum that contain the isolated signals. The computer attempts to identify and calculate spectral parameters for the signals through mathematical algorithms or other computing techniques. Some versions of software allow for a text report to be generated from the resulting signal analysis. The advantage is that the computer can perform calculations needed to generate the textual report faster than a chemist can manually. However, computers cannot always recognize important aspects of a NMR spectrum that an experienced chemist may. Further, even if a computer is used to generate a NMR spectrum textual report, the chemist must still analyze the report and the plots for accuracy. The chemist must still repeat some or all of the same steps that would otherwise be done manually. The chemist must still analyze each of the signals to determine if the computer has correctly characterized a signal in the report, thereby resulting in time delay.

When computer applications are used to transcribe organic compounds into textual reports, the chemist must analyze the regular plot 10 on a computer screen. Due to limitations in computer screen resolution, a plot cannot be typically displayed on one screen with sufficient resolution to be analyzed by a chemist. Chemists have to expand the spectral regions on the plot 10 considerably more than would otherwise have to be performed on a printed copy of the plot 10 due to resolution limitations of computer screens. A laser printed copy of a plot may be 300 dots per inch (dpi) or greater, whereas a computer resolution may be much lower at 72 dpi for example. This results in a time consuming task of the chemist constantly expanding and de-expanding the plot 10 on the computer screen to visualize the individual signals The chemist will also incur fatigue as more NMR spectrums are analyzed on a computer screen versus a printed copy thereby reducing efficiency over time. Therefore, even if a computer system available before the present invention is used to formulate a NMR spectrum textual report, the process is still very time consuming and inefficient.

Computer-controlled transcribing systems also have the disadvantage of taking control away from the user to provide other characterizing data regarding the peaks, such as whether the peak is a singlet or multiplet type peak as well as its number of protons for example, during the transcription process. If a computer where formulating the textual report without assistance from a user, the computer would not only have to know that peaks 29A 29B are peaks and that no other curve forms part of signal 29, but the computer would also have to know that peaks 29A, 29B are located close enough to each other to represent a doublet. The only way for computers to have this intelligence is to execute algorithms that affect threshold levels or tolerances that control the identification of a peak. This introduces error since certain peaks may not always fall into pre-programmed tolerances programmed into the computer, but will be easily recognized by a user/chemist visually looking at the peak on the plot 10. This will result in the user having to recheck and re-review any totally computer generated textual report generation system, thereby introducing timing delays.

The present invention solves the problem of inefficient transcription of NMR spectrum from a plot into textual reports. The present invention provides computer assistance to allow a chemist to more quickly and more efficiently transcribe NMR spectrum into textual reports than by the manual and computer processes commercially available before the present invention. This is because the current invention combines the computational advantages of a computer-based application for performing calculations related to transcribing peak data from a signal into a textual report with a chemist's experience in data visualization of a hard-copy plot that cannot be substituted with a computer.

### SUMMARY OF THE INVENTION

The present invention is a computer assisted method and apparatus to transcribe a nuclear magnetic resonance (NMR) spectrum into a textual report. The present invention involves a user using a graphics tablet containing a NMR stacked plot formed from a NMR spectrum to select peaks. The user will typically be a chemist or other personnel that understands how to interpret NMR spectra. The user uses a pointing device on a tablet containing the NMR spectrum to select peaks. The tablet transmits this information in the form of an x- and y-coordinate point and communicates the coordinate point to application software executing on a computer system. The application software translates the coordinate point information into spectrum coordinates and with the assistance of the user, calculates spectra parameters and outputs a formatted textual report of an organic compound from a plot in an automated fashion that includes standard information about the organic compound, including chemical shifts and coupling constants of peaks.

Because the present invention is based on high-resolution printed plots which can often exceed the size of common computer monitors, the amount of data represented on the plots is considerably greater than what can be represented on a computer screen. The result is a stacked plot, where the user has constant visual access to all the expanded regions of the spectrum. In comparison, the user would need to constantly expand, de-expand or scroll through the spectrum on a computer screen in order to see the same amount of data through a totally computer screen based user interface. The result is a system and method that is free from the data visualization problems that are inherent to a computer screen based user interface.

Because the user manually selects peaks, the user controls which peaks are selected and their location instead of losing this control by a totally computer-controlled and generated textual report. The coordinate point information selected by the user is translated from a graphics representation into a textual report in a highly accurate manner using the assistance of a computer without the user having to make manual calculations to arrive at the textual report. The application software allows the user to see the results of the transcription in real time as the peak data is selected so that the user does not have to re-review the final textual report to check its accuracy.

The user is also given control over providing other characterizing data regarding the signals, such as whether the signal is a triplet or a doublet of doublets type peak for example as well as its number of protons. This allows the user to use their expertise in making these decisions instead of being out of the control of the user and solely in the control of a computer. If a computer is left to make its own decision about location and characterization of peaks, errors will often occur due to the computer's inability to reliably identify the relevant peaks of a signal and ignore extraneous peaks. This will result in the user having to recheck and re-review any totally computer-controlled textual report generation system and introduce timing and inefficiency delays.

A graphics tablet is used by the present invention to transcribe graphical information from a stacked plot into a NMR spectrum textual report. A puck pointing device is used to select buttons and peaks on a template placed on top of the graphics tablet to communicate coordinate point data to an application software program executing on a computer system coupled to the graphics tablet. The buttons on the template relate to instructions information that the user provides to the application software via communication from the graphics tablet to control the transcription of the NMR spectrum into a textual report.

The template placed on top of the graphics tablet consists of a plot area and a virtual button area. A virtual button area is provided as a more efficient method of allowing the user to select information necessary in performing a transcription of the stacked plot graphical information into the NMR textual report. Some of the buttons provided in the button area of the template are also located on the puck itself as puck buttons 56 for convenience and efficiency to the user.

During operation, the user is prompted by the application software for the spectrum type of the spectrum. The user moves the crosshair of the puck over the spectrum button on the template desire to indicate the spectrum type of the spectrum to the application software. The graphics tablet communicates the x- and y-coordinate point of the crosshair of the puck to the application software. The application software is programmed to correlate the x- and y-coordinates into buttons on the template and outputs the spectrum type in the appropriate text format to start the textual report.

The application software next prompts the user for the frequency of the stacked plot. The user moves the crosshair of the puck over the plot frequency button desired on the template and selects the desired frequency. After the user selects the desired frequency, which is communicated from the graphics tablet to the application software, the application software appends the selected frequency to the end of the textual report.

Next, the application software prompts the user to identify the solvent in which the organic chemical sample was dissolved in for the NMR experiment. The user moves the crosshair of the puck over the desired solvent among the solvent buttons on the template and selects the desired solvent. After the user selects the solvent, the application software appends the solvent to the end of the textual report.

Next, the application software prompts the user for the plot layout of the stacked plot on the tablet. The application software must have knowledge of the stacked plot layout so that the application software can use the correct geometric definitions for the stacked plot in order to properly transcribe x- and y-coordinates received from the tablet into peak data in terms of ppm and frequency. The user moves the crosshair of the puck over the desired plot layout among the plot layout buttons on the template and selects the desired plot layout.

Next, the application software prompts the user to calibrate the location of the stacked plot on the tablet so that the application software knows the precise boundaries of the stacked plot in terms of x- and y-coordinates. This is necessary so that the application software can correctly correlate an x- and y-coordinate point on the stacked plot 42 into a spectral position or location in terms of ppm units on the stacked plot 42. The user moves the crosshair of the puck over the reference points in a sequential fashion to provide the application software with the x- and y-coordinates of the reference points.

After the user has selected the reference points of the stacked plot, the user is prompted to click the peaks of the signals on the stacked plot and to indicate their signal type. The user begins by placing the crosshair of the puck over top the first peak of the desired signal on the stacked plot and selecting the peak. This causes the tablet to transmit the x- and y-coordinate point of the peak to the application software. The application software calculates the NMR spectral position from the point selected. The user then repeats this step for the remaining peaks in the signal until all the relevant peaks in the signal have been designated. Next, the user selects the peak type (singlet, doublet, etc.) by either selecting the appropriate button on the template or buttons provided on the puck. The application software then calculates the appropriate NMR spectral parameters from the selected NMR spectral positions and appends the information to the report in the appropriate textual format.

Next, the application software prompts the user for the number of protons present in the peak. The application software then appends the proton information to the report. The application software waits to determine if the user desires to select additional peaks on the stacked plot, append mass spectrum (MS) and/or elemental analysis (CHN) data to the report, or end the report. The application software continues to append data regarding selected peaks, and/or MS and/or CHN data to the report until the user indicates that the report is completed.

Note that the order of steps described above could be rearranged, and the present invention is not limited to any particular order.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1A is a diagram of regular plot of NMR spectrum for the chemical compound 3-(3-pyridyl)-1-propanol;

FIG. 1B is a diagram of the regular plot of NMR spectrum illustrated in FIG. 1A over an expanded region;

FIG. 2A is a diagram of a standardized expanded stacked plot of the NMR spectrum illustrated in FIG. 1A;

FIG. 2B illustrates a transcription of the NMR spectrum illustrated in FIG. 1A into a textual report;

FIG. 3 is an illustration of a graphics tablet, also called a “tablet” or a “digitizer,” and pointing device, also called a “puck,” or a “crosshair cursor” that is used in the present invention to transcribe NMR spectrum into a textual report;

FIG. 4A is an illustration of the template used with the present invention to affix on the graphics tablet used in transcribing NMR spectrum into a textual report;

FIG. 4B is a close-up illustration of certain buttons on the template illustrated in FIG. 4A;

FIG. 4C is a close-up illustration of other buttons on the template illustrated in FIG. 4A;

FIG. 5 is an block diagram illustrating the physical components of the graphics tablet communicatively coupled to a computer system for use in the present invention;

FIGS. 6A and 6B contain a flowchart illustrating the operation of the present invention;

FIG. 7 is a diagram of a software user interface executing on a computer system coupled to the graphics tablet to NMR spectrum data from the graphics tablet to convert such data into a textual report;

FIG. 8 is a diagram of the puck used to send information to the computer system whereby the puck is selecting that the NMR spectrum is a proton spectrum;

FIG. 9 is a diagram of the user interface prompting the user for the frequency of the NMR spectrum;

FIG. 10 is a diagram of the user interface prompting the user for the solvent used to dissolve the chemical compound for the NMR experiment;

FIG. 11 is a diagram of the user interface prompting the user for the plot layout of the NMR spectrum plot illustrated in FIG. 3;

FIG. 12 is a diagram of the user interface prompting the user for the first reference position of the NMR spectrum plot to calibrate the puck;

FIG. 13 is a diagram of the puck placed over top the first reference position to communicate to the computer system the coordinates of the first reference position on the graphics tablet;

FIG. 14 is a diagram of the user interface prompting the user to click on a peak on the NMR spectrum plot on the graphics tablet to transcribe the peak into a textual report on the user interface;

FIG. 15A is a diagram of the puck placed over top the first peak of a doublet to communicate the location and frequency of the peak to the computer system;

FIG. 15B is a diagram of the user interface indicating the ppm value and frequency of the first peak and prompting the user to click on the next peak in the signal;

FIG. 15C is a diagram of the puck placed over top the second peak of a doublet to communicate the location and frequency of the peak to the computer system;

FIG. 15D is a diagram of the user interface indicating the location and frequency of the second peak in the first doublet and prompting the user to click on a signal type;

FIG. 15E is a diagram of a transcription of the first doublet peak into a textual report and prompting the user for the number of protons in the first doublet peak;

FIG. 15F is a diagram of the user interface appending the number of protons in the first doublet peak in the report and prompting the user for the location and frequency of the next peak;

FIG. 16 is a diagram of the user interface with the next peak transcribed and included in the report;

FIG. 17A is a diagram of the user interface with the location and frequency of six peaks in the positions box;

FIG. 17B is a diagram of the puck placed over top the doublet of triplets button to indicate that the six peaks in the positions box are a doublet of triplets;

FIG. 17C is a diagram of the user interface appending the peak data and number of protons of the doublet of triplets peak illustrated in the positions box in FIG. 17A in the report and prompting the user for the location and frequency of the next peak;

FIG. 18A is a diagram of the puck placed over top the mass spectrum button to append mass spectrum information to the report;

FIG. 18B is a diagram of the user interface with the mass spectrum button report window open for the user to select the type of mass spectrum function to append to the report;

FIG. 18C is a diagram of the user interface with the mass spectrum data window open for the user to enter the mass spectrum data;

FIG. 18D is a diagram of the user interface with the mass spectrum data appended to the report;

FIG. 19A is a diagram of the puck placed over top the CHN button to append CHN information to the report;

FIG. 19B is a diagram of the user interface with the CHN report window open for the user to enter CHN data;

FIG. 19C is a diagram of the user interface illustrating a finished report of the NMR spectrum illustrated in the plot in FIG. 1A and prompting the user to start the next report; and

FIG. 20 is a diagram of the user interface illustrating the finished report of the NMR spectrum as illustrated in FIG. 19 with the selection of the spectrum type for the next report shown.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

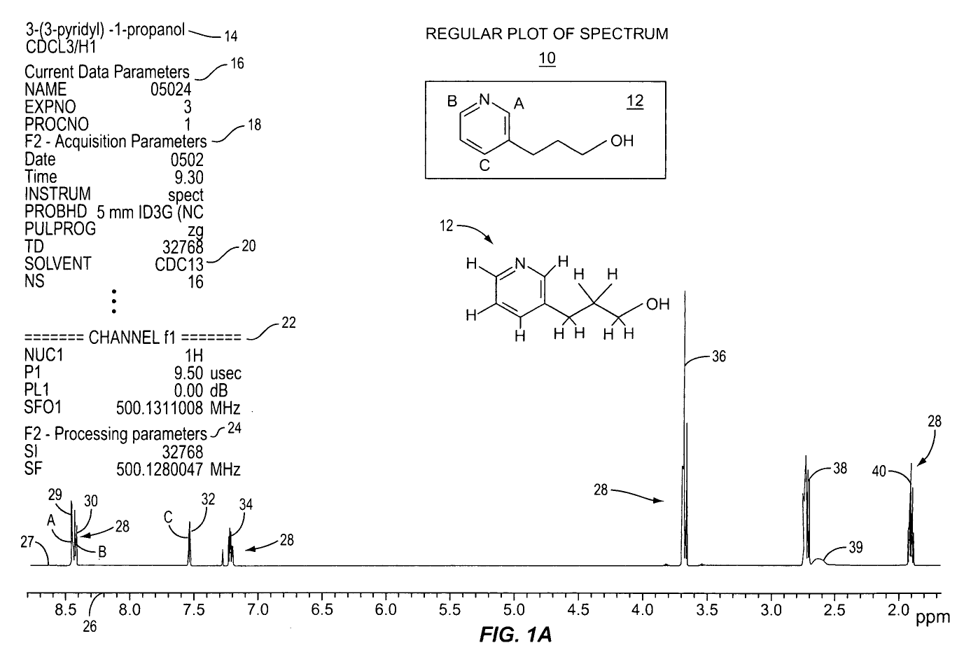

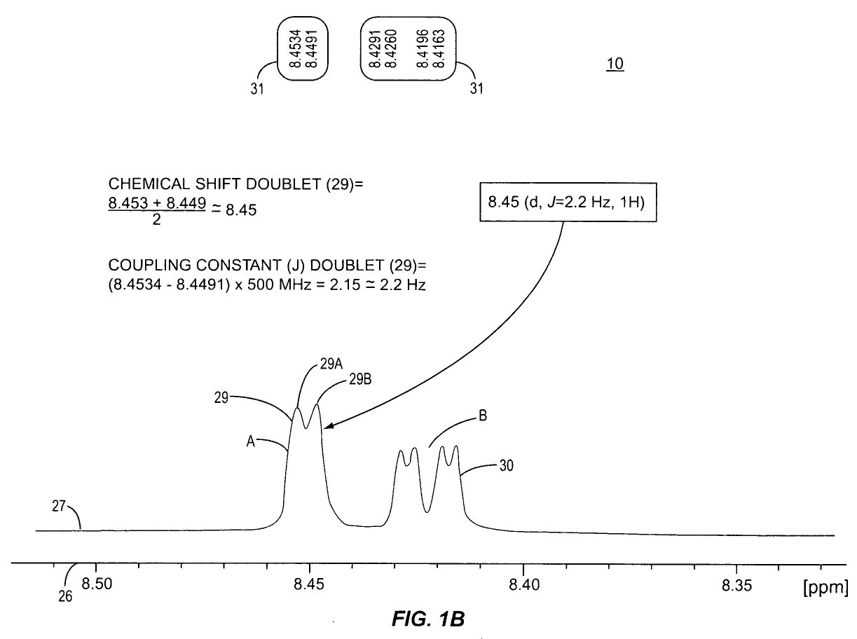

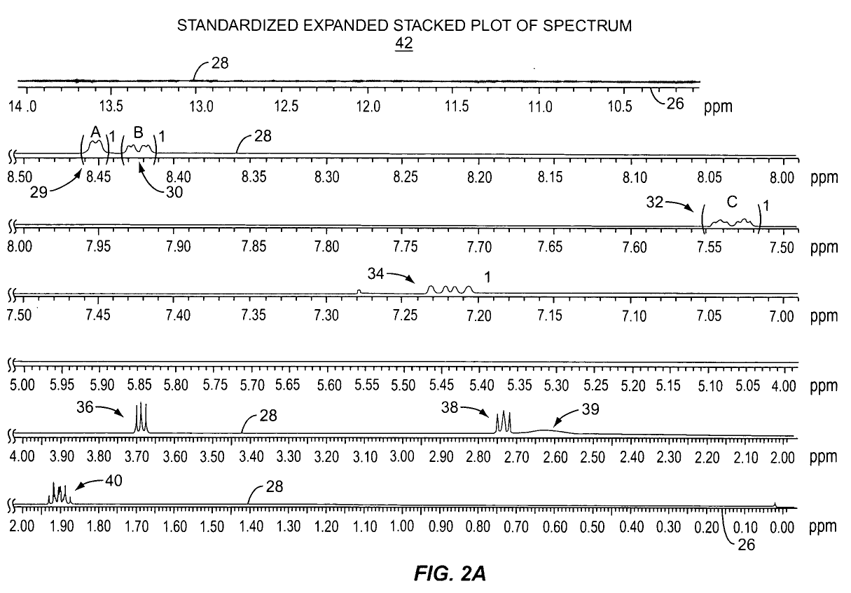

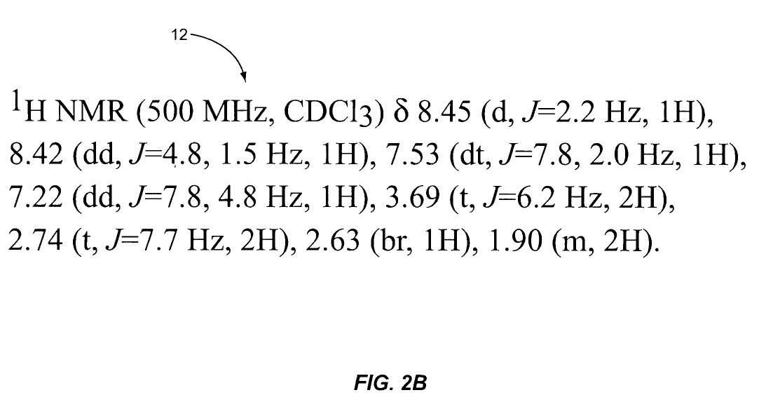

FIG. 2A illustrates the NMR spectrum illustrated in FIG. 1A, but through a different type of plot called a “standardized expanded stacked plot of spectrum” 42, also called a “stacked plot.” In the stacked plot 42, the spectrum is divided into small sections wherein each section is expanded horizontally. The regions of the plot 10 are plotted in a predetermined stacked fashion. The stacked plot 42 enables a chemist to more easily see the exact formation of the signals 29, 30, 32, 34, 36, 38, 39, 40 so that the NMR spectrum can be described in a textual report. The stacked plot 42 also expands the horizontal component of the spectrum sufficiently that the locations of the peaks can be designated by a user using the pointing device (introduced below) without pointing error being significant. In the plot 42 in FIG. 2A, signals 29, 30, and 32 have parenthesis that have been draw around the peaks by a chemist manually which are not part of the plot 42 as generated by a computer. These notations were simply included by the chemist as a convenience to relate signals 29, 30, 32 to portions of the organic compound 12 as illustrated in FIG. 1A. Also, the stacked plot 42 in FIG. 2A does not show certain areas of the spectrum where peaks are not present due to sizing constraints of the figure. An actual stacked plot would include regions that cover the entire range of the spectrum, possibly with the exception of regions lower than 0 ppm or higher than 10 ppm. The textual report of the organic compound 12 is listed in FIG. 2B for the present example.

The present invention is a computer assisted method and apparatus to transcribe a nuclear magnetic resonance (NMR) spectrum into a textual report. The present invention involves a user using a graphics tablet or a digitizer containing a NMR stacked plot to select and characterize signals. The graphics tablet or digitizer can be any device that coverts a selected point to a coordinate, and the terms “graphics tablet” and “digitizer” can be used interchangeably. The user will typically be a chemist or other personnel who understands how to interpret NMR spectrum. The user uses a pointing device on a tablet containing the NMR spectrum to select peaks. The tablet transcribes this information in the form of an x- and y-coordinate point and communicates the coordinate point to application software executing on a computer system. The application software transcribes the coordinate point information into spectrum coordinates, and with the assistance of the user, transcribes graphical coordinate point information into spectral parameters and a NMR spectrum textual report containing those parameters.

Because the user manually selects peaks, the user controls which peaks are selected and their exact location instead of losing this control by a totally computer-controlled and generated textual report. The peak selected by the user is converted into a coordinate point in a highly accurate manner using the assistance of a graphics tablet so that the user does not have to derive the coordinate point manually. The application software allows the user to see the results of the transcription in real time as the peak data is selected so that the user does not have to re-review the final textual report to check its accuracy.

The user is also given control over providing other characterizing data regarding the peaks, such as whether the peak is a singlet or multiplet type peak as well as its number of protons. This allows the user to use their expertise in making these decisions instead of such decisions being out of control of the user and solely in the control of a computer. If a computer is left to make its own decision about location and characterization of peaks, errors will often occur due to the computer's inability to reliably identify the relevant peaks of a signal and ignore extraneous peaks. This will result in the user having to recheck and re-review any totally computer-controlled textual report generation system, which will introduce timing and inaccuracy delays.

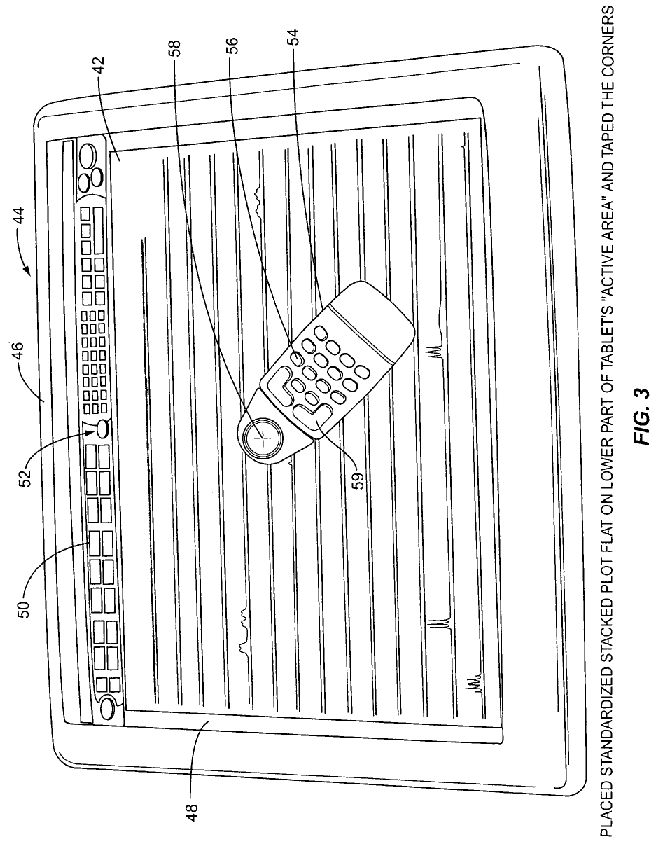

Before describing the operational aspects of the present invention, FIGS. 3-5 are first discussed to introduce and describe the physical components of the present invention.

Physical Components

FIG. 3 illustrates a graphics tablet 44 that is used by the present invention to transcribe graphical information from the stacked plot 42 into data to comprise the NMR spectrum textual report. In the example illustrated in FIG. 3, the graphics tablet 44 is comprised of a outer housing 46, typically made of hardened plastic with a tablet surface 48 being provided on top to attach a stacked plot 42 when used in accordance with the present invention. A graphics tablet is designed to convert locations on the tablet surface 48 selected by a pointing device, such as an electronic pen, mouse, or crosshair cursor, into coordinate point data relative to the tablet surface 48. For instance, the lower left bottom location in the tablet surface 48 may be coordinate point (0, 0). The graphics tablet 44 illustrated in FIG. 3 is manufactured by GTCO Calcomp, Inc. and is described in more detail at http://www.gtcocalcomp.com.

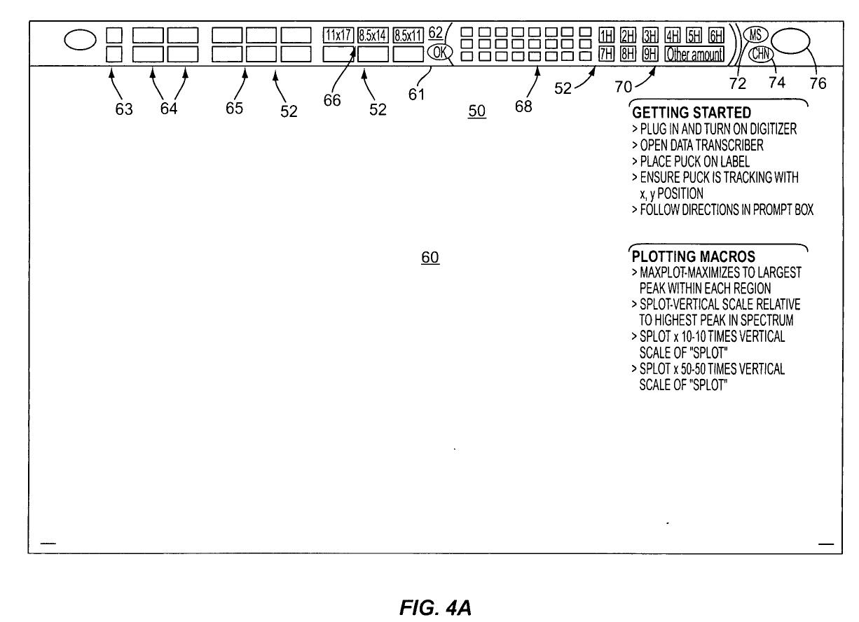

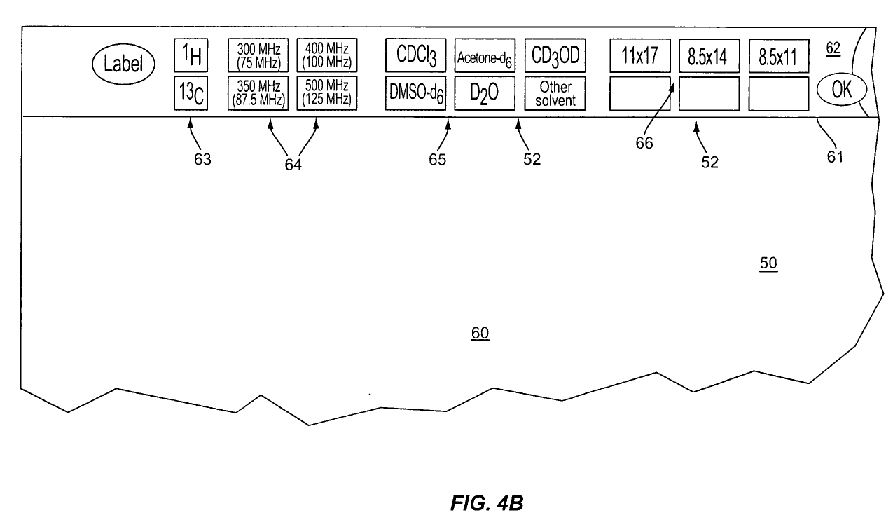

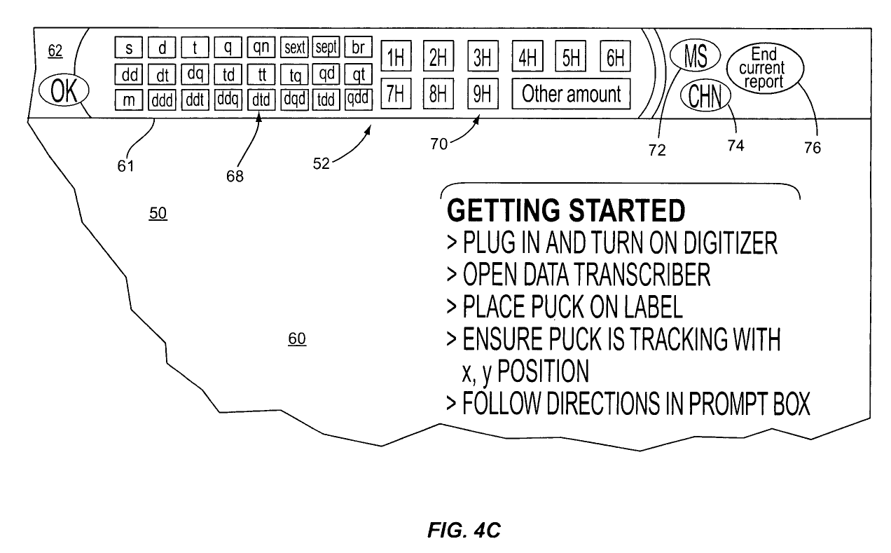

A template 50, illustrated in more detail in FIGS. 4A-4C, is laid on the tablet surface 48. The template 50 in accordance with the present invention provides virtual buttons 52 in a virtual buttons area 62 that can be selected when using the present invention as described below. Virtual buttons 52 are not regular buttons, but rather a pre-defined area on the template 50 where selection of an area within the boundary of the button 52 will be registered as a button selection by the application software (discussed later below). The stacked plot 44 is placed on top of the template 50 and secured in place with tape, adhesive, or any immobilization method. In the present example, the template 50 is adapted to hold a 11″×17″ sized layout stacked plot 42 or smaller. However, a tablet could be used that accepts other template and stacked plot layouts. Note that the stacked plot 42 does not cover the entire template 50. Buttons 52 are exposed at the top of the template 50 so that the user can select these buttons 52 when desired using a puck 54, as will be described later in this application.

A point device or puck 54 is used with the graphics tablet 44 to transcribe graphical information into coordinate point data. In the present example, the graphics tablet 44 is a two-dimensional tablet, which translates a location in an x- and y-coordinate point. The puck 54 consists of buttons 56 and a crosshair 58. The puck 54 is used to align the crosshair 58 with an area of interest on the stacked plot 42 or the template buttons 52. When the enter button 59 from among the puck buttons 56 is pressed by a user, the graphics tablet 44 generates an x- and y-coordinate point data of the relative location of the crosshair 58 and communicates this information to another computer system as will be discussed below in more detail.

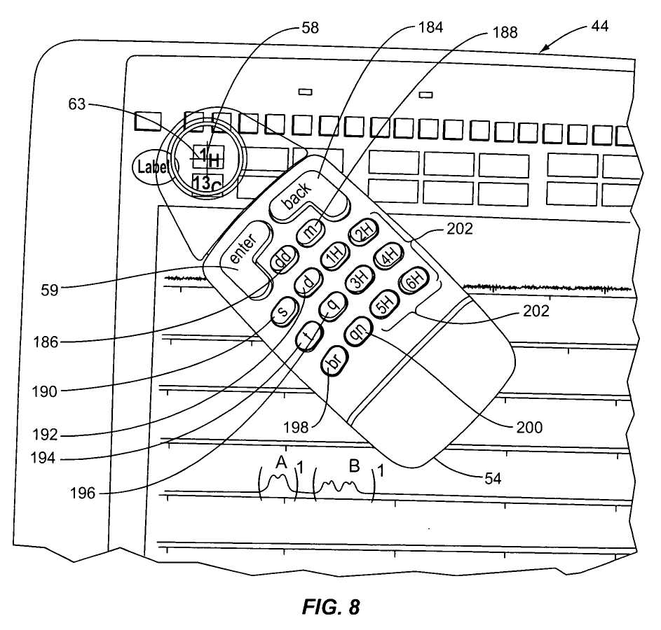

FIG. 4A illustrates an example of the template 50 that is used with the present invention to place inside the tablet surface 48. The template 50 consists of a plot area 60 separated by a dividing line 61 from the virtual button area 62. The virtual button area 62 is provided as a more efficient method of allowing the user to select control buttons necessary in directing a transcription of the stacked plot 42 graphical information into the NMR textual report. In this manner, the user does not have to select such buttons on a separate computer system thereby adding inefficiency. Some of the buttons provided in the button area 62 are also located on the puck 54 itself (the puck buttons 56) for convenience and efficiency to the user. More information about the puck buttons 56 is provided in FIG. 8 during the operational discussion of the present invention.

Spectrum type buttons 63 are provided on the template 50 in the button area 62. As illustrated in FIG. 4B, which is a close up of certain buttons on the template 50 illustrated in FIG. 4A, the user can select either the “¹H” or “¹³C” button to indicate the spectrum type of the NMR spectrum in the stacked plot 42. The user can select the frequency of the NMR spectrum in the stacked plot 42 by selecting one of the plot frequency buttons 64. The user can select the solvent used to dissolve the organic compound 12 represented by the stacked plot 42 by selecting one of the solvent buttons 65. The user can select the plot layout of the stacked plot 42, used to indicate the area of the tablet surface 48 where the stacked plot 42 will approximately be located, by selecting one of the plot layout buttons 66.

As illustrated in FIG. 4C, which is a close up of other buttons on the template 50 illustrated in FIG. 4A, the user can also select one of the signal type buttons 68 to indicate a type of peak on the stacked plot 42 when selecting peaks using the puck 54 as will be described later in this application. The user can select one of the proton buttons 70 to indicate the number of protons in a peak selected on the stacked plot 42 as will be described later in this application. Lastly, the template 50 also includes a mass spectrum (MS) button 72 and an elemental analysis (CHN) button 74 that can be selected by the user if MS and/or CHN information is desired to be appended to the textual report of the NMR spectrum as will be shown by example later in this application. When the user desires to end the current report, meaning that there is no more information to be added to the text report, the user can select the end current report button 76.

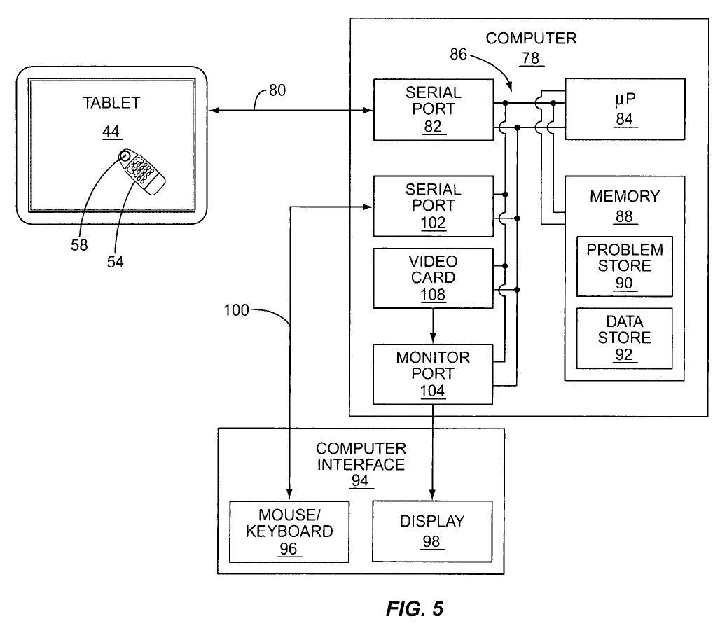

FIG. 5 illustrates a block diagram of physical components of the graphics tablet 44 communicatively coupled to a computer system 78 for transmitting button and coordinate point information regarding the stacked plot 42 from the graphics tablet 44 to the computer 78. The computer 78 includes application software (not shown) that generates the textual report of the NMR spectrum from data received by the graphics tablet 44 via a communications channel 80, which may a wired cable or a wireless communications connection. In the present example, the graphics tablet 44 is communicatively connected to the computer 78 using a serial port cable 80. The serial port cable 80 is connected to a serial port 82 in the computer 78. The serial port 82 may be a universal serial port (USB) for example. If not, a serial port to USB adapter (not shown) may be used if serial port 82 is not compatible with the graphics tablet 44.

The computer 78 includes typical components of a computer system including a microprocessor 84 and memory 88, including program store 90 and data store 92. The microprocessor 84 access the memory 88 via a bus 86 that includes address, data and control lines. Other peripheral devices are connected to the bus 86 for control by the microprocessor 84, which includes the serial port 82, a serial port 102 for coupling the computer 78 to an computer interface 94 input device, such as a mouse or keyboard 96 using a serial cable 100, and a video card 108 for controlling information displayed to a monitor or display 98 via a monitor port 104. The application software is loaded into the program memory 90 to execute a computer program used to receive information from the graphics tablet 44 regarding the stacked plot 42 to formulate the NMR spectrum textual report.

Operational Aspects

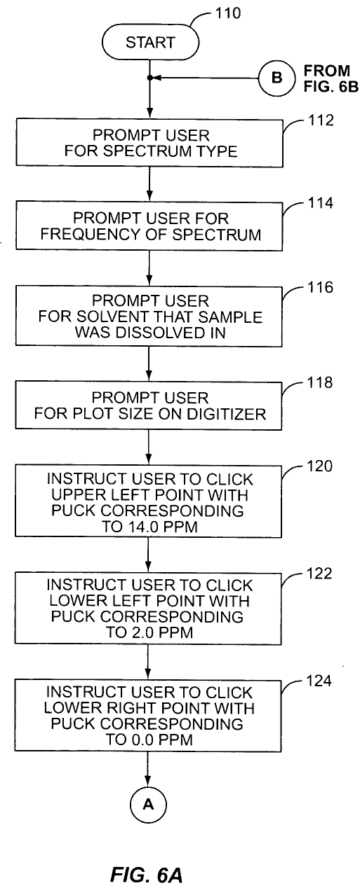

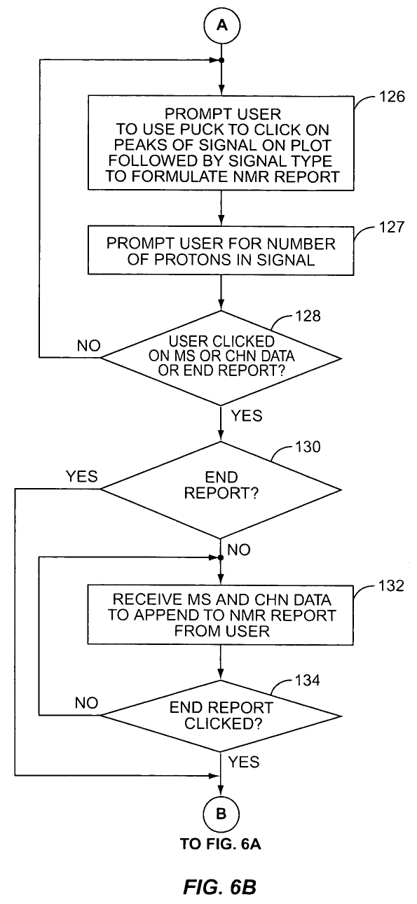

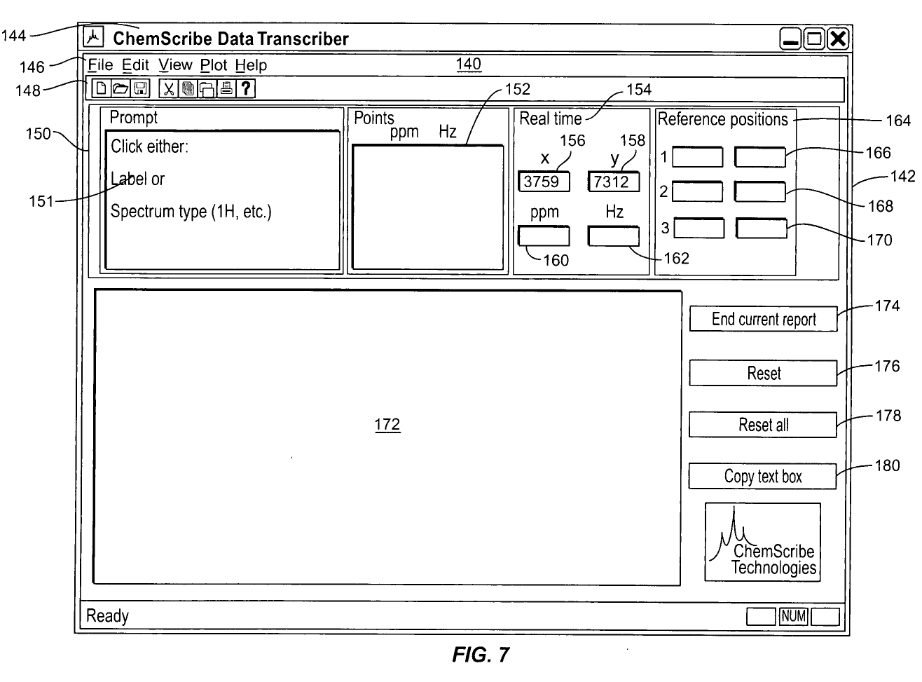

Now that the physical and hardware components of the system in accordance with the present invention have been described, the remainder of this application describes the operational aspects of how NMR spectrum is converted from the graphical representation in the stacked plot 42 using the tablet 44 to a textual report by the application software executing on the computer 78. The flowchart illustrated in FIGS. 6A and 6B describe the operational process of the present invention. The individual steps in the process of the present invention illustrated in the flow charts in FIGS. 6A and 6B are described in FIGS. 7-20. Note that the steps in FIGS. 6A and 6B and as described above can be performed in any order, and the present invention is not limited to any particular order of these steps being performed to carry out the present invention.

As illustrated in FIG. 6A, the process starts (step 110), and the user is prompted by the application software for the spectrum type of the stacked plot 42 on the tablet 44 (step 112). An illustration of step 112 is illustrated in FIG. 7. FIG. 7 illustrates a user interface 140 that is caused to be displayed by the application software on the display 98. In the example illustrated in FIG. 7, the user interface 140 is in the form of a Microsoft® Window® since the computer 78 is executing a Microsoft® operating system. However, any type of operating system or display may be used by the computer 78 for the present invention.

The user interface 140 contains the name of the application software 144—the “ChemScribe Data Transcriber,” as well as menu items 146 and control buttons 148 to allow the user to control operation of the user interface 140 as designed. The user interface 140 includes a prompt box 150 that contains a prompt text area 151 for visual instructions to the user. In FIG. 7, the prompt box 150 is asking the user to click either the “Label” or “Spectrum type” of the stacked plot 142 located on the graphics tablet 44.

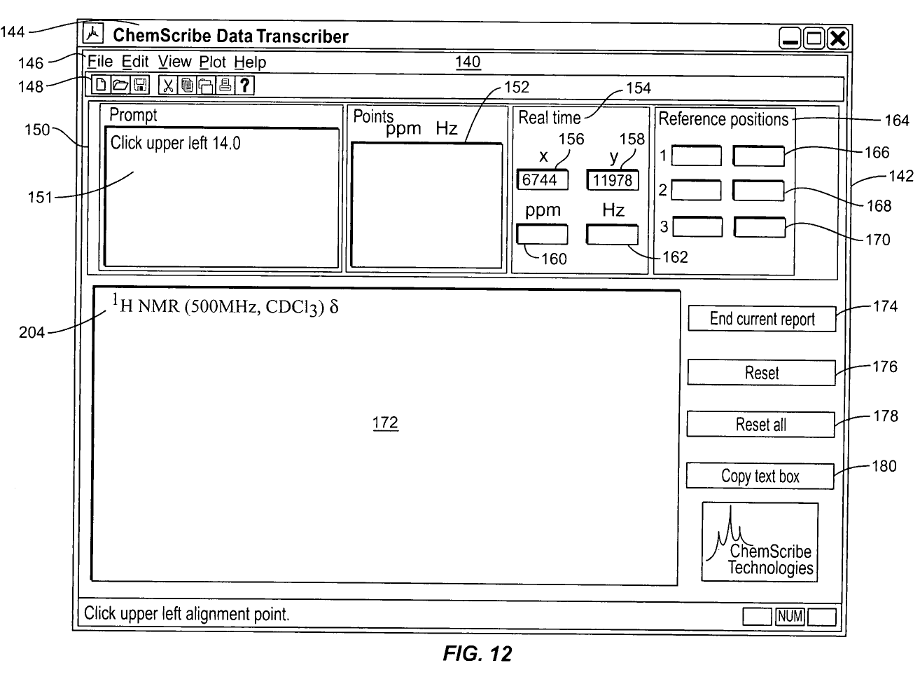

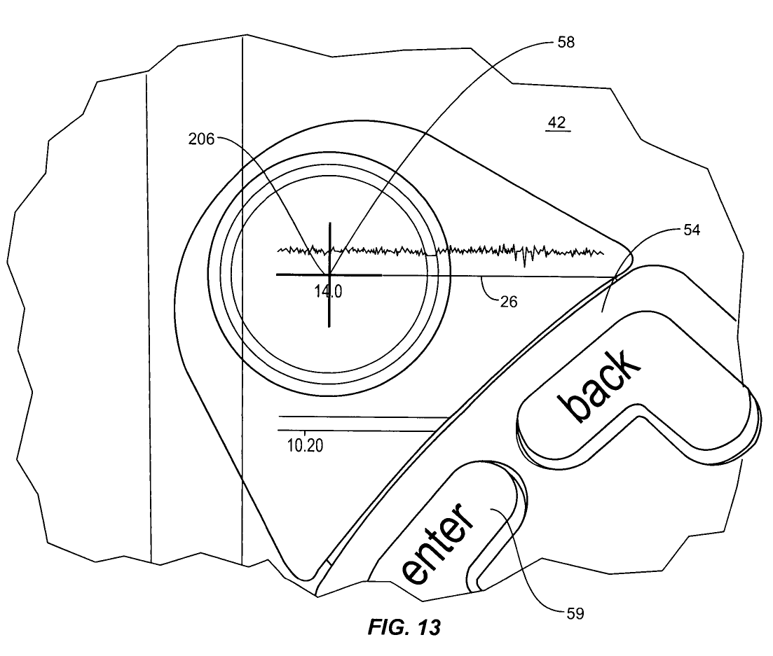

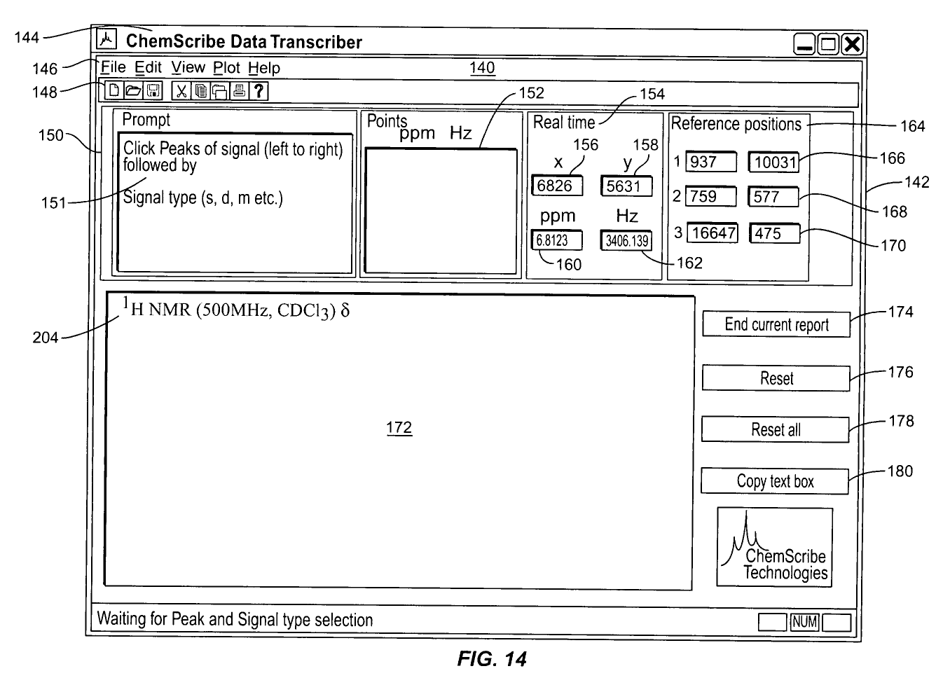

The user interface 140 also includes various other information that is introduced here, but will be more relevantly discussed as the discussion of the present invention in this application continues. A positions box 152 lists any peak positions, listed in the format of points, that the user has selected on the stacked plot 42 before the positions are directed to be transcribed into the textual report. Note that the term “point” and “position” may be used interchangeably throughout this application. The real time box 154 contains an instantaneous location of the crosshair 58 on the tablet 44 via an x-coordinate 156 and a y-coordinate point 158. The application software uses these coordinate points 156, 158 to generate the textual report. When the user interface 140 is ready to accept peak information from the stacked plot 42 (illustrated in FIG. 14), the user interface 140 will also display the position of the crosshair 58 on the tablet 44 in terms of ppm and frequency (Hz) on the stacked plot 42 in the ppm coordinate 160 and Hertz coordinate 162. The reference positions box 164 contains three reference positions 166, 168, 170 in terms of x- and y-coordinate points which marks the boundaries of the stacked plot 42 when placed on the tablet 44 and calibrated by the user as will be described in FIGS. 12 and 13. As the application software is transcribing the NMR spectrum textual report, the report appears in the report area 172 of the user interface 140.

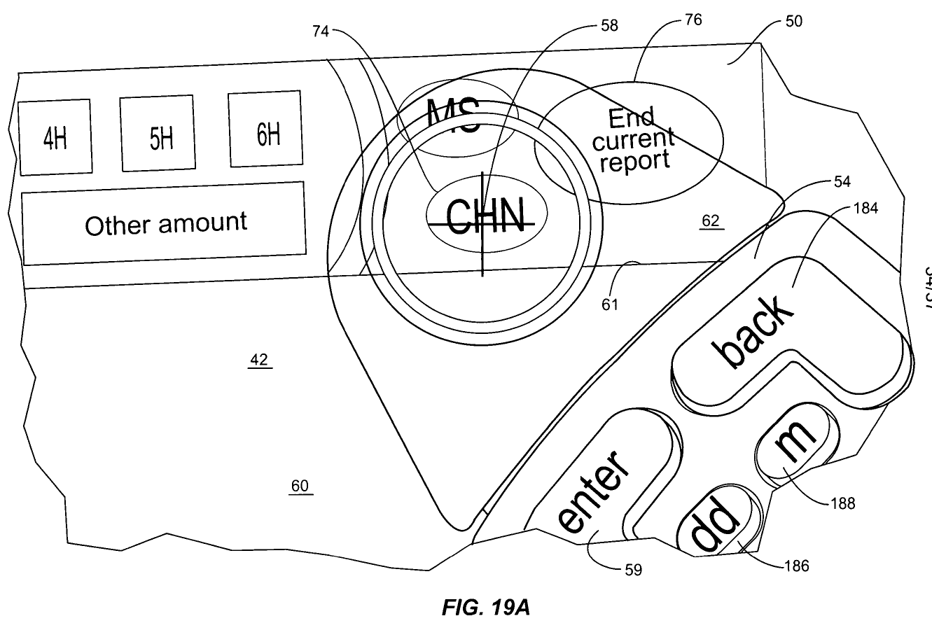

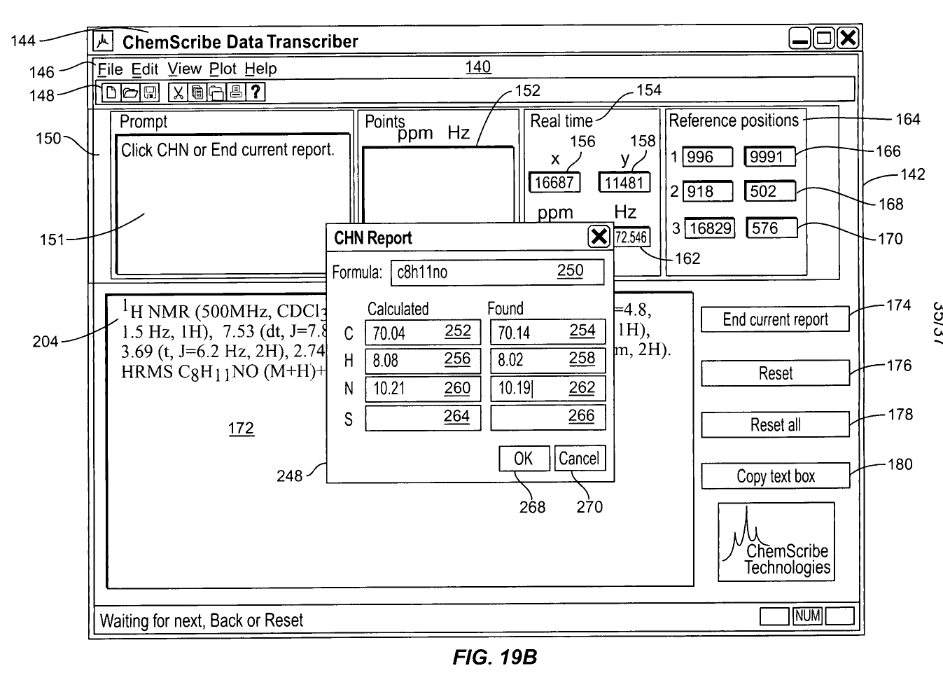

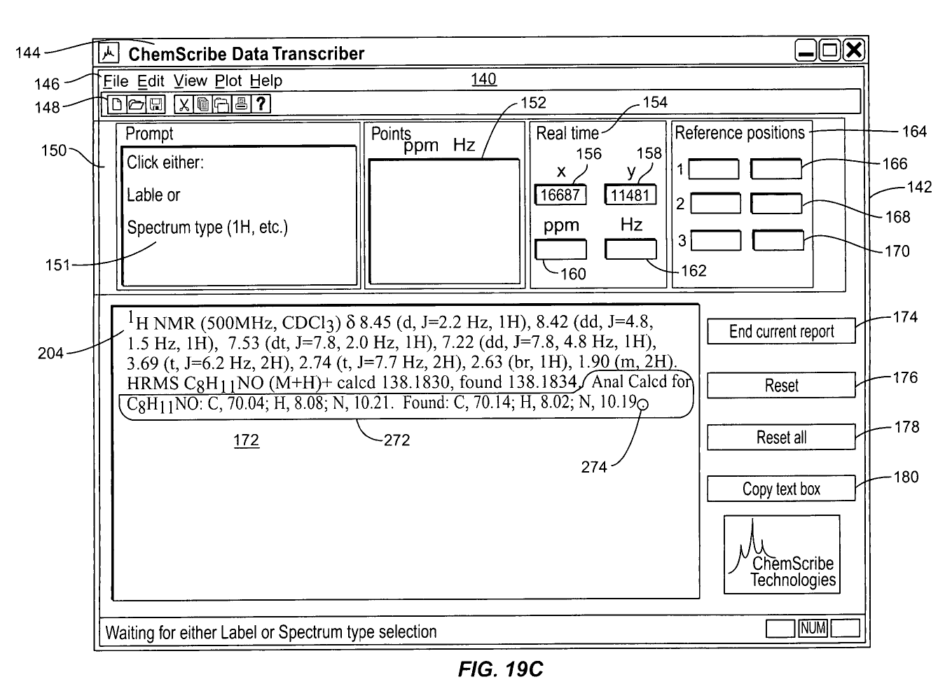

The user can also select other buttons on the user interface 140—the end current report button 174, the reset button 176, the reset all button 178, and the copy text box button 180, to control functions of the application software and the textual report. The end current report button 174 ends the current textual report as will described in FIG. 19C. The reset button 176 erases the current text report from the report area 172, clears all positions in the positions box 152, and resets the prompt 151 to the beginning prompt (step 112 in FIG. 6A). The reset all button 178 erases all reports in the entire report area 172, clears all positions in the positions box 152, and resets the prompt 151 to the beginning prompt (step 112 in FIG. 6A).

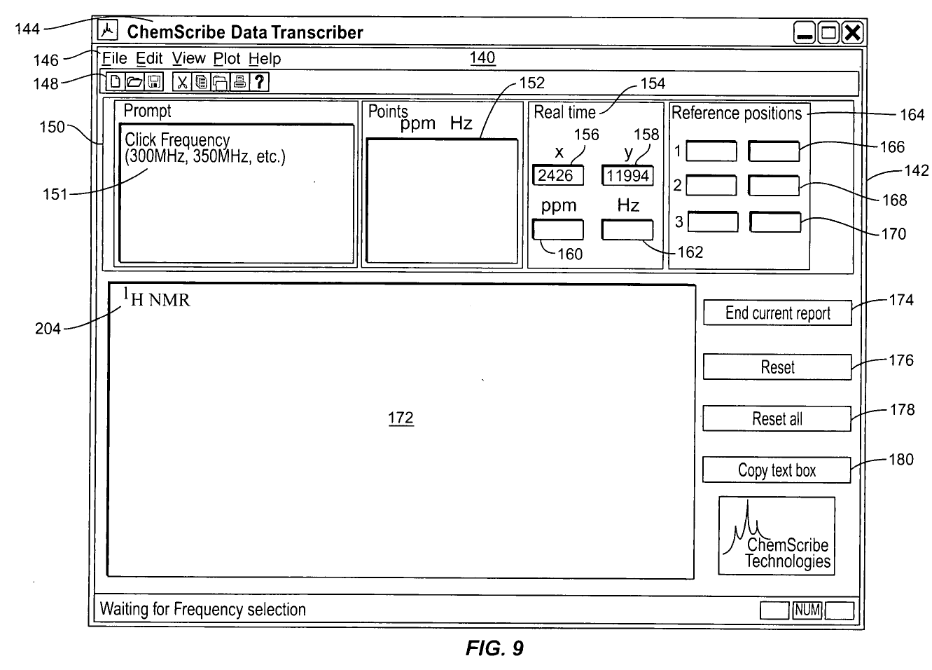

FIG. 8 illustrates the graphics tablet 44 with the crosshair 58 of the puck 54 placed over top the “¹H” spectrum button 63. The user has moved the crosshair 58 over the “¹H” button to answer the prompt to the user in FIG. 7 to indicate the spectrum type of the stacked plot 42. The stacked plot 42 on the tablet 44 is a “¹H” spectrum type. After the user places the crosshair 58 over the “¹H” button 63, the user hits the “ENTER” button 59 on the puck 54. As illustrated in FIG. 9, the application software inserts the text “¹H NMR” in the first report 204 in the report area 172 indicating that the current report 204 is of a “¹H” spectrum type report.

Though not used at this stage of the process, there are other puck buttons 56 that may be used to send information to the application software to direct the application software in creating the NMR spectrum textual report. These buttons 56 will be described here before continuing with the description of the transcribing process. The puck buttons 56 include the following buttons which are selected by the user when selecting peaks on the stacked plot 42 to further characterize information about peaks. These buttons 56 are included on the puck 54 as a convenience to the user and are well understood by one of ordinary skill in the art. The puck 54 includes a “BACK” button 184 that instructs the application software to undo the previous step, acting as a backspace key. Some of the buttons 56 are also included in the buttons area 62 of the template, which can also be selected by the user by placing the crosshair 58 of the puck 54 over the button desired and pressing the “ENTER” button 59.

| Button (56) label | Item No. | Description |
|---|---|---|
| “dd” | 186 | doublet of doublet |
| “m” | 188 | multiplet |
| “s” | 190 | singlet |
| “d” | 192 | doublet |
| “t” | 194 | triplet |
| “q” | 196 | quartet |
| “br” | 198 | broad singlet |
| “qn” | 200 | quintet |
| “1H” | 202 | 1 proton |
| “2H” | 202 | 2 protons |
| “3H” | 202 | 3 protons |
| “4H” | 202 | 4 protons |
| “5H” | 202 | 5 protons |
| “6H” | 202 | 6 protons |

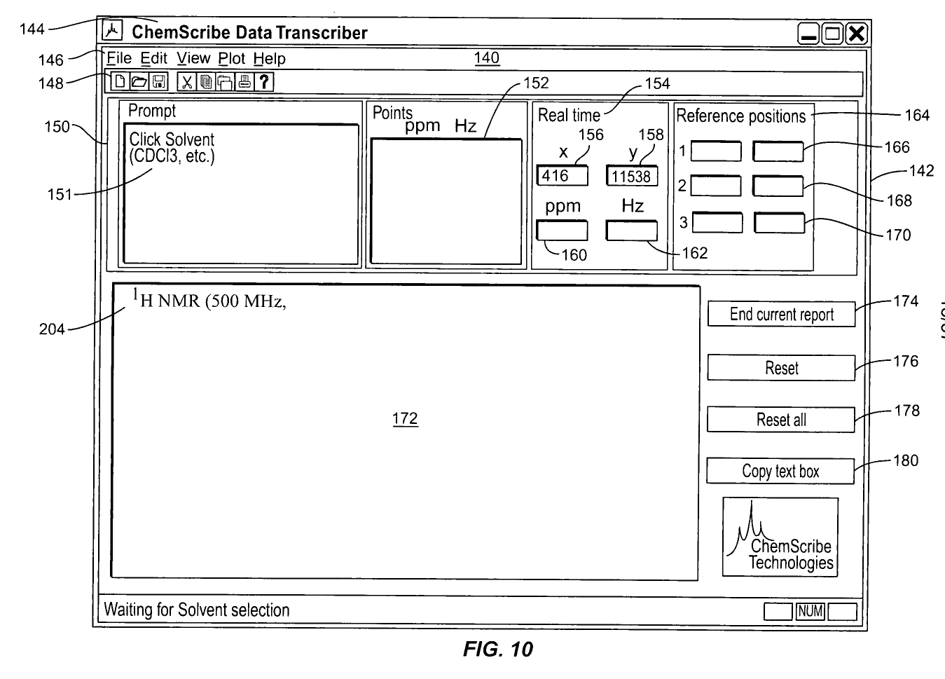

Continuing with the process illustrated in FIG. 6A, the application software next prompts the user for the frequency of the spectrum as shown by the prompt text 151 in the prompt box 150 in FIG. 9 (step 114). The user moves the crosshair 58 of the puck 54 over the plot frequency button 64 desired and selects the desired frequency by pressing the “ENTER” button 59 on the puck 54. As illustrated in FIG. 10, after the user selects the desired frequency, the frequency selected is appended to the end of the first report 204. In the present example, the user has selected 500 MHz.

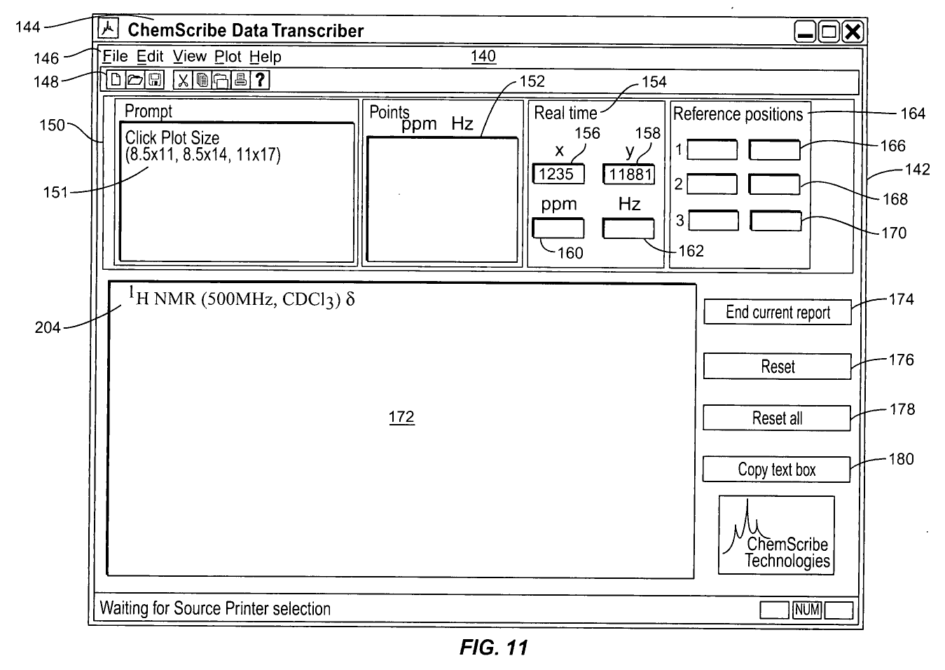

Next, the application software prompts the user for the solvent that the organic chemical sample described on the stacked plot 42 was dissolved in (step 116 in FIG. 6A). This prompt text 151 is illustrated in FIG. 10 in the prompt box 150. The user moves the crosshair 58 of the puck 54 over the desired solvent among the solvent buttons 65 and selects the desired solvent by pressing the “ENTER” button 59 on the puck 54. As illustrated in FIG. 11, after the user selects the solvent, the solvent selected is appended to the end of the first report 204. In the present example, the user has selected CDCl₃ as the solvent.

Next, the application software prompts the user for the plot layout and sizing of the stacked plot 42 on the tablet 44 (step 118 in FIG. 6A). This prompt text 151 is illustrated in FIG. 11 in the prompt box 150. The application software must have knowledge of the stacked plot 42 plot layout so that the application software can use the correct geometric definitions to properly transcribe peak data in terms of ppm and frequency. The user moves the crosshair 58 of the puck 54 over the desired plot layout among the plot layout buttons 66 and selects the desired plot layout by pressing the “ENTER” button 59 on the puck 54.

The application software is pre-programmed with information about different layouts of stacked plots 44 that can be placed onto the graphics tablet 44 so that the application software can translate a coordinate point received from the graphics tablet 44 into a location on the stacked plot 44. The software application is programmed with geometric definitions of standardized stacked plots so that the distance between grid axes 26 is known. The software application is programmed with the specific arrangement of spectral regions of standard stacked plots. Knowing the distance between grid axes 26 and the range of grid axes 26 stacked on top of each other, the application software can transcribe a location of the crosshair 58 to specific region of the grid axis 26 to correctly transcribe an x- and y-coordinate point selected by the puck 54 to a point on the stacked plot 42 in terms of ppm and frequency spectral position.

Next, the application software prompts the user to calibrate the location of the stacked plot 42 on the tablet 44 so that the application software knows the precise boundaries of the stacked plot 42 in terms of x- and y-coordinate points from the tablet 44 (steps 120-124 in FIG. 6A). This is necessary so that the application software can correctly transcribe an x- and y-coordinate point on the stacked plot 42 into a NMR spectral position in terms of ppm and frequency on the stacked plot 42. The application software has knowledge of the relative locations of all grid axes 26 from certain calibration or reference positions as described above, and thus the application software being instructed of the precise location of the reference positions in terms of x- and y-coordinate points allows the application software to precisely transcribe a peak position selected by the user using the puck 54 on the stacked plot 42.

The three reference positions used by the application software are dependent on the plot layout selected for the stacked plot 42. In the present example, the reference positions of the stacked plot 42 are 14.0 ppm, 2.0 ppm, and 0.0 ppm. As illustrated by the prompt text 151 in the prompt text box 150 in the user interface 140 illustrated in FIG. 12, the user is prompted for the location of first reference position—14.0 ppm. As illustrated in FIG. 13, the user moves the crosshair 58 of the puck 54 over top the location of 14.0 ppm on the grid axis 26 and presses the “ENTER” button 59 on the puck 54. This provides the application software the x- and y-coordinate point location of the 14.0 ppm position on the stacked plot 42 on the grid axis 26. The user is prompted by the application software for the location of the other two reference positions—2.0 ppm and 0.0 ppm in the same manner (not illustrated) in steps 122 and 124 in FIG. 6A.

Turning now to the flow chart in FIG. 6B, after the user has selected the reference positions of the stacked plot 42 as instructed by the user interface 140, the user is prompted by the prompt text 151 in the prompt text box 150, as illustrated in FIG. 14, to click the peaks of the signals 28 and to indicate the signal type (step 126 in FIG. 6B). Note that FIG. 14 also shows the reference positions for 14.0 ppm, 2.0 ppm, and 0.0 ppm in the reference positions box 164 as reference positions 1, 2, and 3, respectively 166, 168, 170. Because the ppm value of the reference positions can vary based on the plot layout, the reference positions in the reference positions box 164 are listed as positions 1, 2 and 3 only.

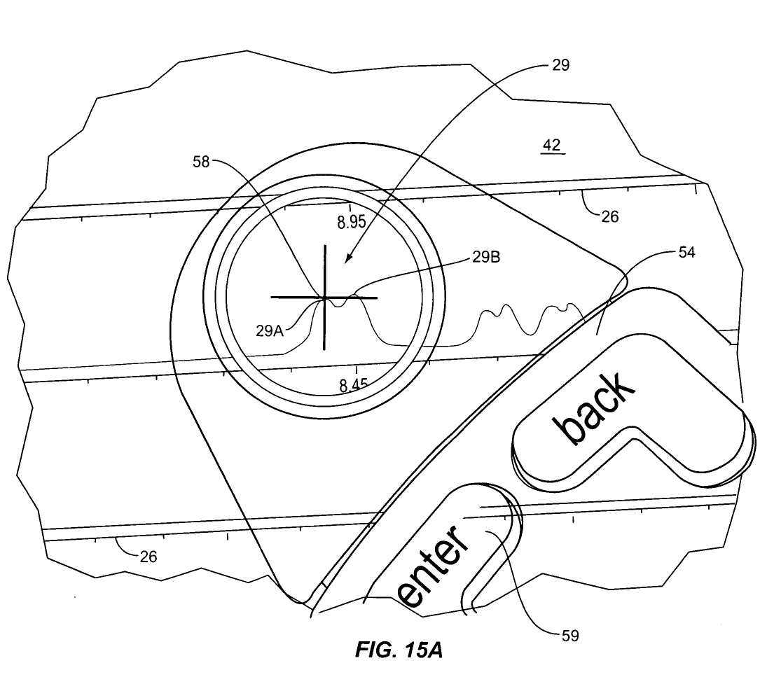

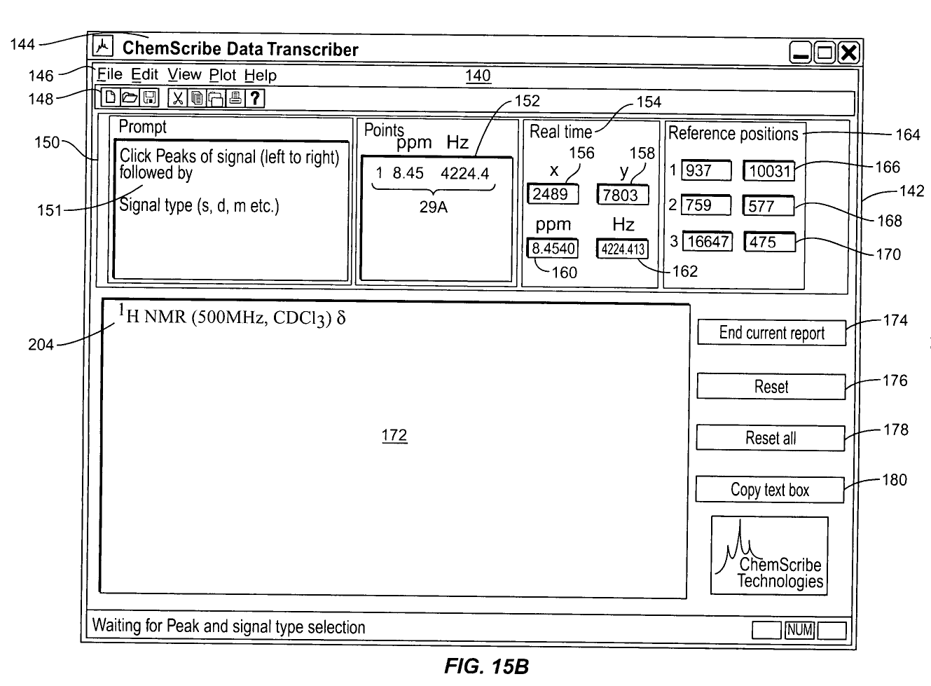

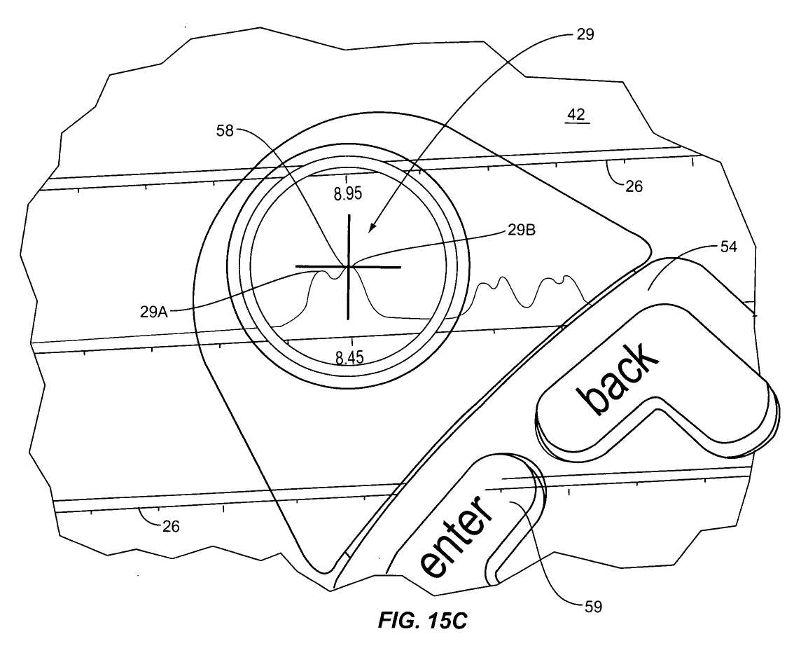

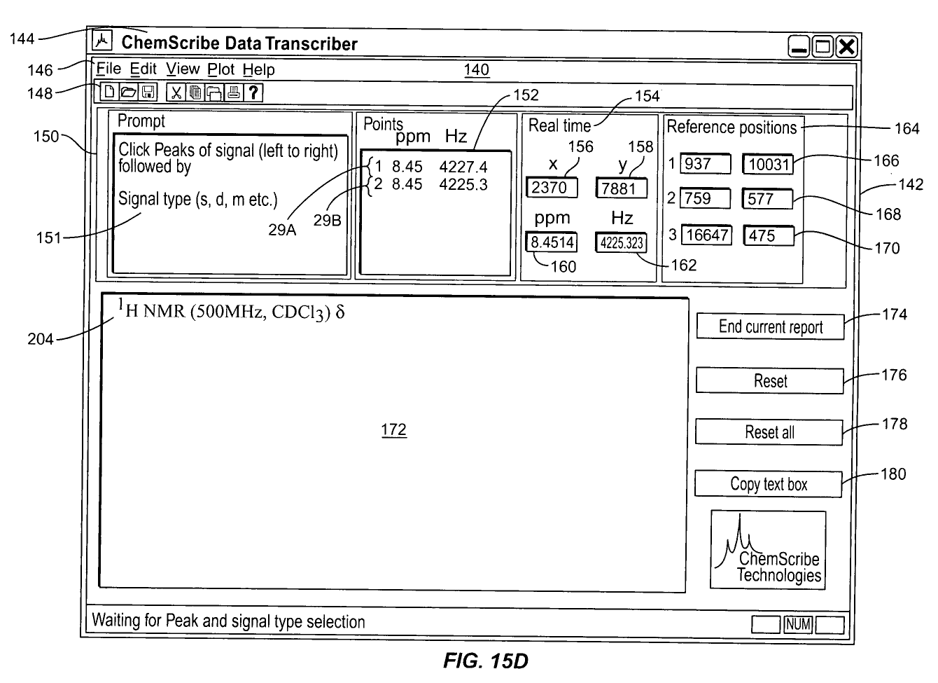

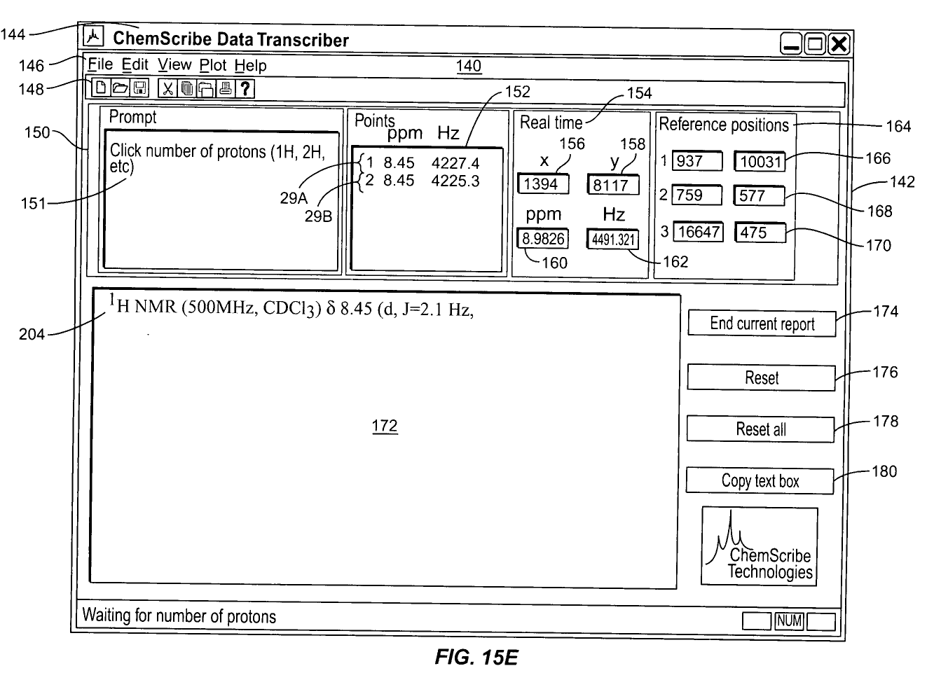

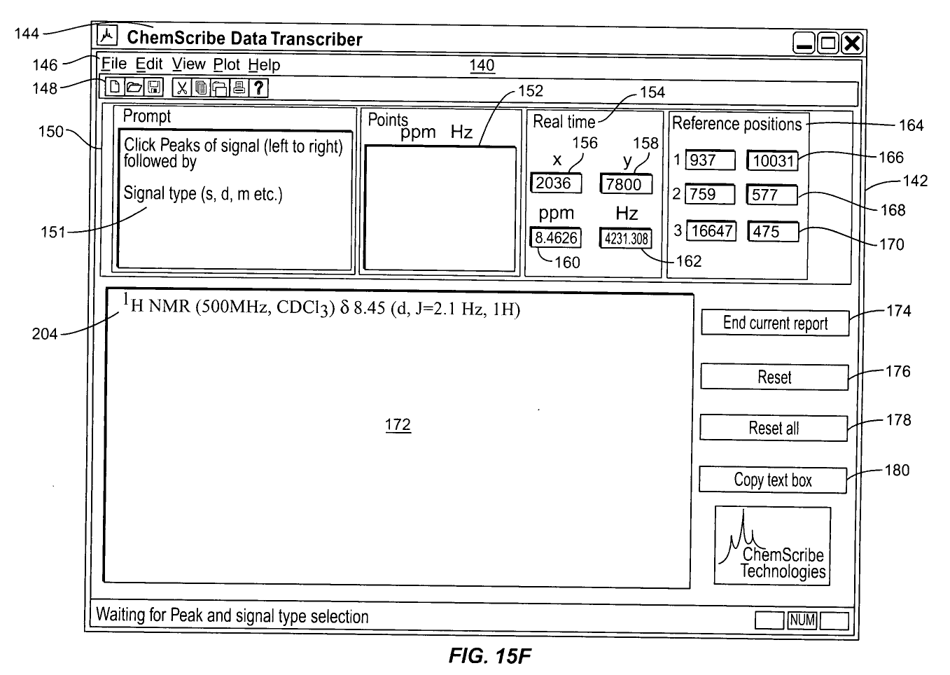

As illustrated in FIG. 15A, the user begins by placing the crosshair 58 of the puck 54 over top the first peak 29A in the signal 29 on the stacked plot. Signal 29 is comprised of two peaks 29A, 29B. The user presses the “ENTER” button 59 on the puck 54 after the crosshair 58 is located on the first peak 29A as illustrated in FIG. 15A. This causes the tablet 44 to transmit the x- and y-coordinate point of peak 29A to the application software. FIG. 15B illustrates the user interface 140 after the user selects the peak 29A. Note that in the positions box 152, the user interface 140 display the location of the peak 29A, position number 1, in terms of 8.45 ppm and 4224.4 Hz. The application software used the geometric definition of the stacked plot 42 along with the location of the reference positions to convert the x- and y-coordinate points of the peak 29A (which is illustrated in the real time box 154 as x-coordinate 2489 (156) and y-coordinate 7803 (158)) to 8.4540 ppm and 4224.413 Hz, illustrated in the ppm and Hertz spectral position coordinates 160, 162. The application software rounded the ppm and Hertz spectral position coordinates 160, 162 to arrive at 8.45 ppm and 4224.4 Hz for peak 29A.

Because signal 29 may be comprised of a peak other than a singlet type peak, the user interface 140 continues to prompt the user for other peaks in signal 29 as illustrated in FIG. 15B. In the present example, signal 29 is a doublet, and peak 29B is the second peak of the doublet 29. As illustrated in FIG. 15C, the user places the crosshair 58 of the puck 54 over top the second peak 29B of the doublet 29 and presses the “ENTER” button 59 on the puck 54. This causes the location of the peak 29B to be communicated to the application software. As discussed above for peak 29A, the user interface 140 displays peak 29B as position number 2 in the positions box 152 being 8.45 ppm and 4225.3 Hz. Note again that the real time box 154 displays the exact x- and y-coordinate points 156, 158 and the ppm and Hertz spectral position coordinates 160, 162 of peak 29B.

At this point, the user knows that signal 29 is a doublet. Again, this accentuates an advantage of the present invention over other computer-controlled methods of transcribing NMR spectrum into a textual report. If a computer where formulating the textual report, the computer would not only have to know that peaks 29A and 29B are peaks and that no other curve forming signal 29 is the peak, but the computer would also have to know that peaks 29A, 29B are located close enough to each other to represent a doublet. The only way for computers to have this intelligence is for them to be pre-programmed with threshold distances or tolerances that indicate set characterizations of a peak. This introduces error since certain peaks may not always fall into pre-programmed tolerances programmed into the computer, but will be easily recognized by a chemist visually looking at the peak on a regular and/or stacked plot 10, 42.

The user, knowing that peak 29 is a doublet, can now click the “d” button or doublet button 192 on the puck 54, or select this button from among the signal type buttons 68 in the button area 62 of the template 50. By the user indicating the peak type, the application software knows that all peak information for signal 29 is completed and no other positions or points comprise signal 29. FIG. 15E illustrates the result of the user selecting the peak type of signal 29. Note that the application software appended the text “(d, J=2.1 Hz,” to the first report 204, meaning that signal 29 is a doublet (d), with calculated chemical shift being at 8.45 ppm and the coupling constant being 2.1 Hz as is understood by one of ordinary skill in the art.

As also illustrated in FIG. 15E, the application software next prompts the user for the number of protons present in signal 29 (step 127 in FIG. 6B). As illustrated in FIG. 1A, signal 29 integrates for one proton. The user can then quickly select one proton for signal 29 by either pressing the “1H” button 202 on the puck 54, or selecting the “1H” button from among the proton buttons 70 on the template 50. FIG. 15F now shows a completed transcription of signal 29 in the first report 204. Providing proton buttons 70 on the puck 54 is an ergonomic design that allows faster input of protons into the application software.

The application software now knows that all relevant information about signal 29 has been received. The application software next waits to determine if the user is finished with selecting peak data on the stacked plot 42. The application software waits until the user either selects to append additional data to the first report 204 or end the current report, or select another peak from the stacked plot 42 on the tablet 44 (decision 128 in FIG. 6B). If the user selects peaks from another signal 28 meaning that the current report is not finished, the process returns back to step 126 in FIG. 6B. In the present example, other peak data needs to be selected from the stacked plot 42 by the user.

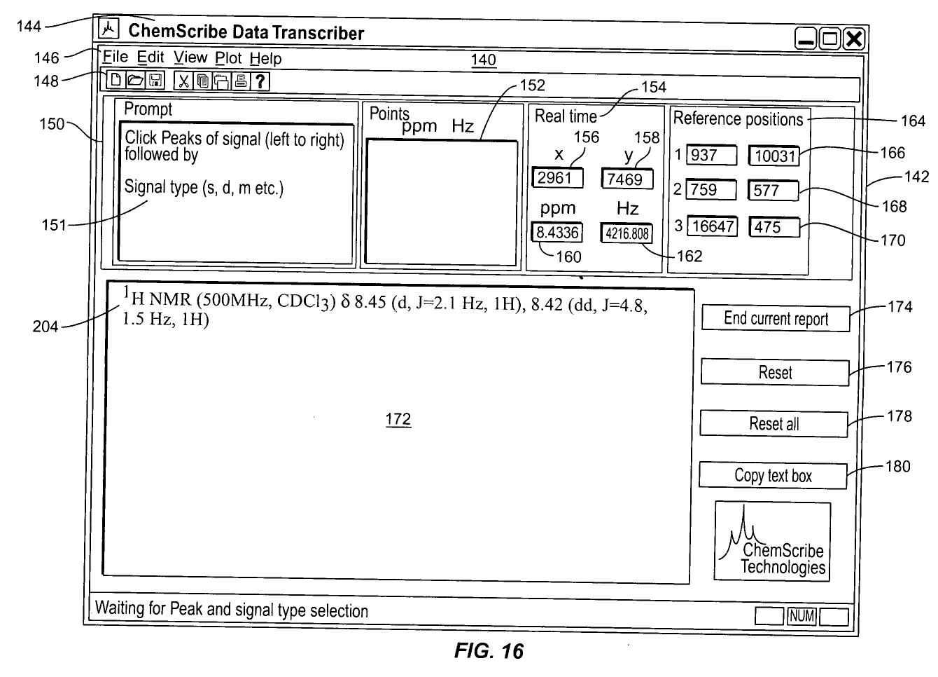

The next signal 28 on the stacked plot 42 is signal 30. Signal 30 is a doublet of doublets consisting of peaks 30A, 30B, 30C, and 30D. As described above, each peak 30A, 30B, 30C, and 30D is selected by the user using the puck 54. Once all four peaks 30A, 30B, 30C, and 30D have been selected as points on the tablet 44, the user selects the “dd” button 186 or 68 to signal the application software that all four positions representing peaks 30A, 30B, 30C, 30D are to be used in transcribing signal 30 as a doublet of doublets. Once this occurs, the application software appends the text “8.42 (dd, J=4.8, 1.5 Hz,” to the first report 204 as illustrated in FIG. 16. Thereafter, the user selects signal 30 as integrating for one proton, thereby causing the application software to append “1 H)” to the first report 204 to describe signal 30 as “8.42 (dd, J=4.8, 1.5 Hz, 1 H)” as illustrated in FIG. 16.

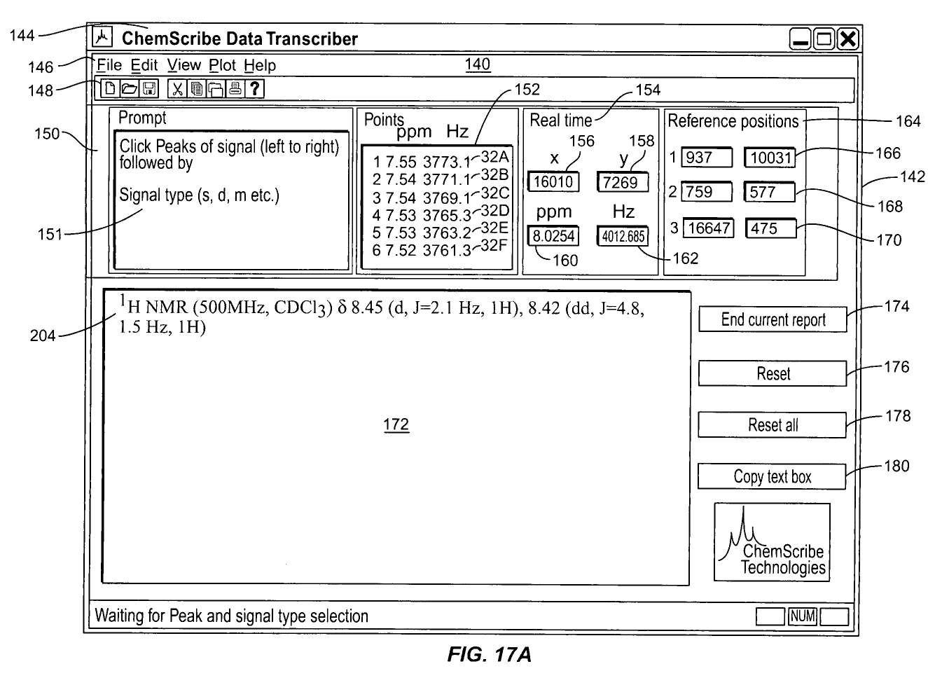

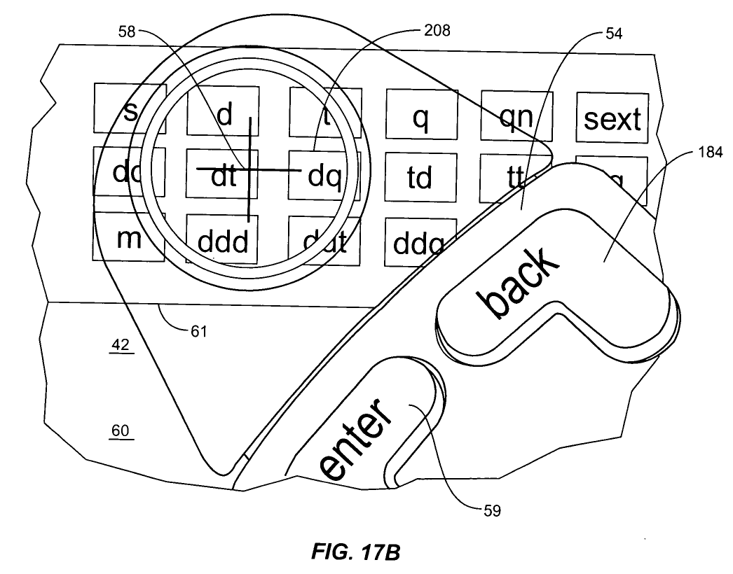

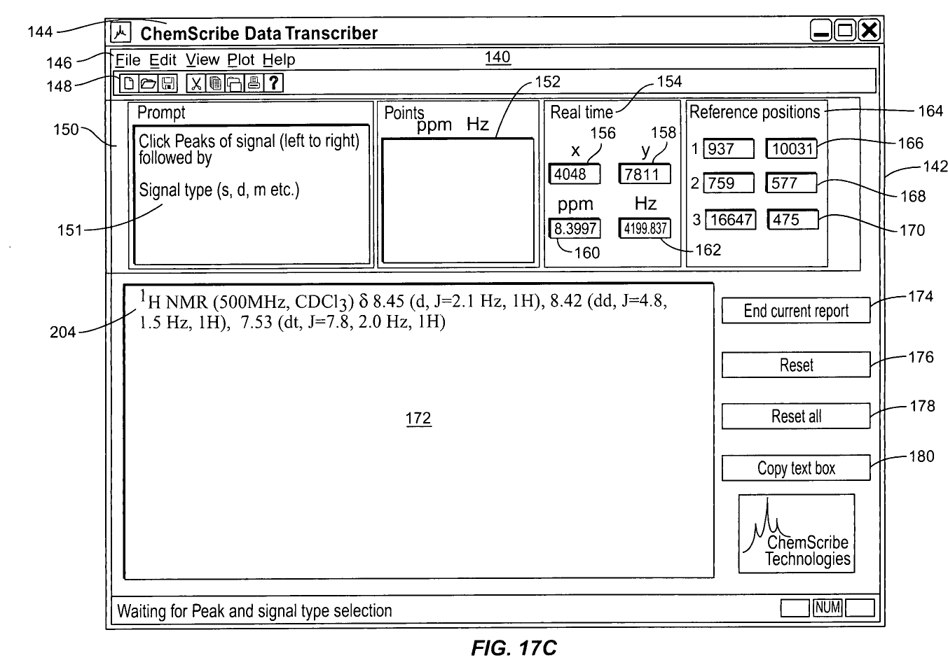

FIG. 17A illustrates the next signal 32, which is a doublet of triplets consisting of six peaks 32A, 32B, 32C, 32D, 32E, 32F. All six positions for peaks 32A, 32B, 32C, 32D, 32E, 32F have been selected by the user and are shown in the positions box 154 as positions one through six, labeled 32A, 32B, 32C, 32D, 32E, 32F. Thereafter, as illustrated in FIG. 17B, the user selects the “dt” button 208 using the puck 54 to indicate to the application software that signal 32 is doublet of triplets. A “dt” button is not present on the puck 54 as a puck button 56 due to space limitations, so the user in this example must select the “dt” button 208 in the button area 62 of the template 50. However, the puck buttons 56 can be designed to accommodate more buttons with additional functionality than the puck 54 contains in the present example.

FIG. 17C illustrates the final transcription of signal 32 in the final report by the amended text “7.53 (dt, J=7.8, 2.0 Hz, 1 H).” The process as described above continues by the user inputting peak information from the other signal 34, 36, 38, 39, 40, on the stacked plot 42 into the application software for appending a transcribed representation of such peaks to the first report 204 (not illustrated). The entire textual report for the first report is illustrated in FIG. 2B.

After the user has selected all peaks from all signals in the stacked plot 42 such that the application software has transcribed such into the report 204, the user can use buttons on the template 50 to append additional data to the report 204 as a convenience to the user. This additional data includes MS data and CHN data. As illustrated in decision 128 in FIG. 6B, the application software decides whether the user is finished selecting all peak data on the stacked plot 42 on the tablet 44. If yes, this means the user has either selected to append additional information to the report 204 or has decided to end the current report 204. If the user has not selected to end the current report (decision 130, FIG. 6B), the user has selected to append MS and/or CHN data to the current report 204.

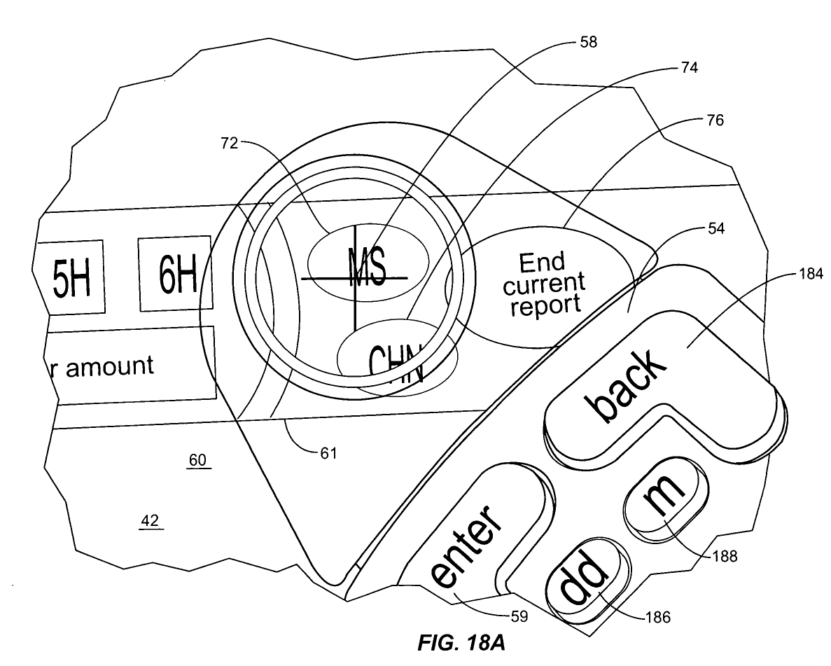

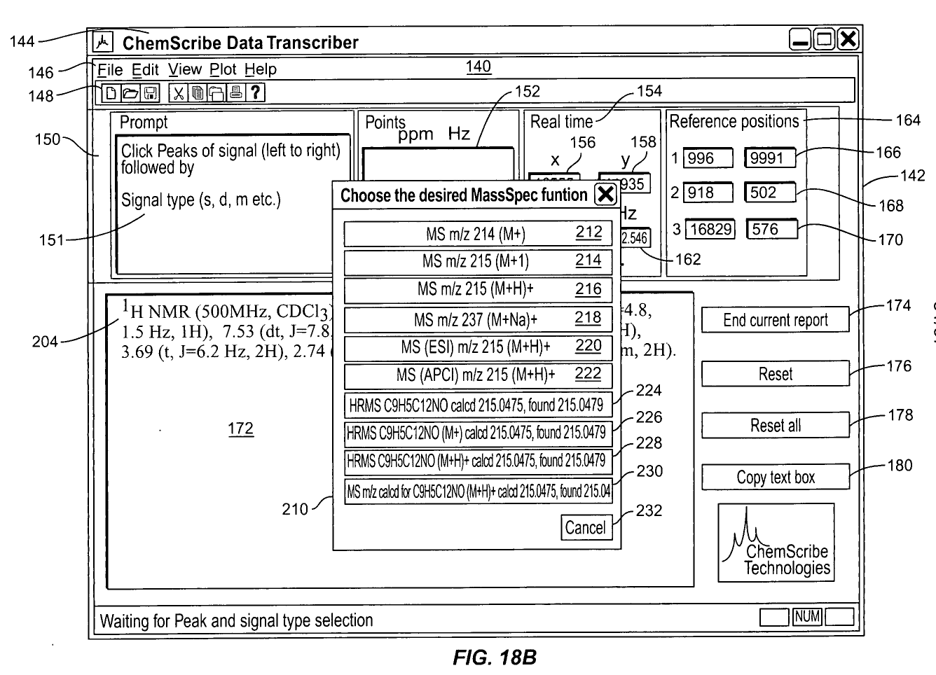

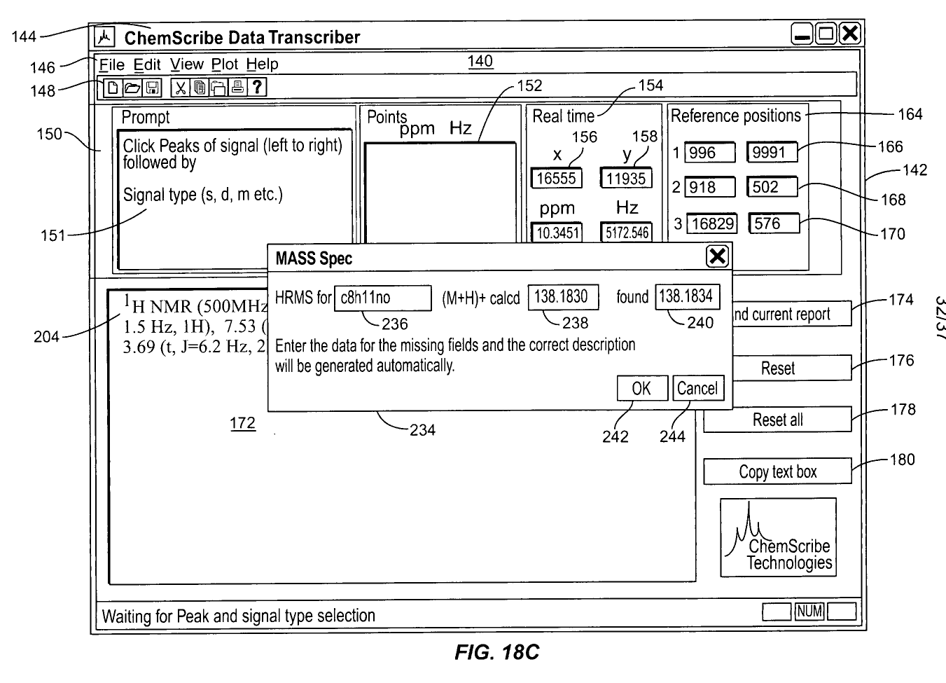

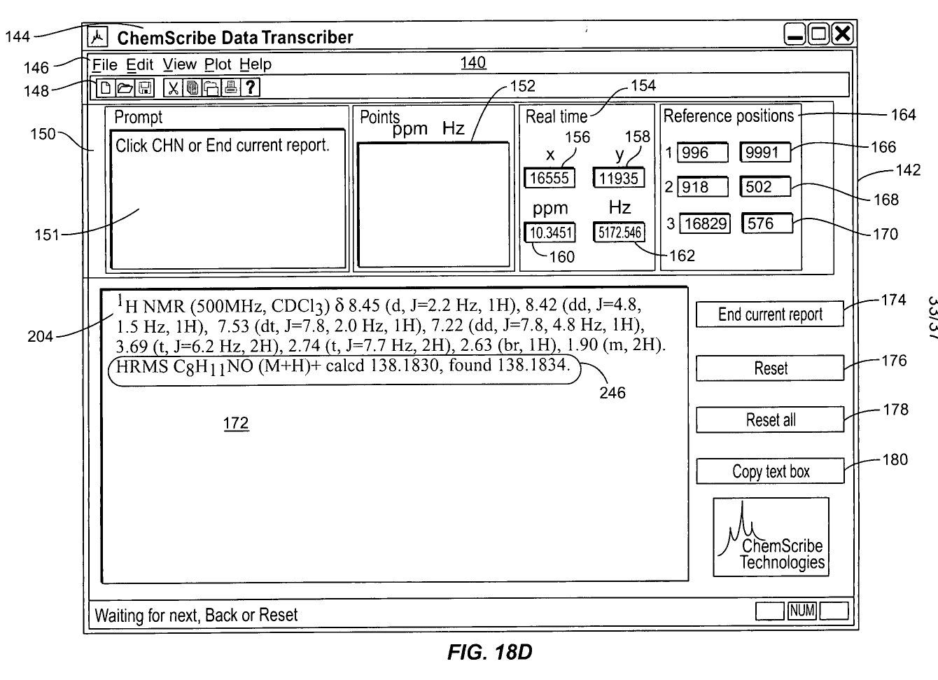

As illustrated in step 132 of FIG. 6B, the user can append data to the current report 204 after all peak data has been selected by the user and transcribed by the application software into the report 204 (decision 132). FIG. 18A illustrates the user placing the crosshair 58 of the puck 54 over the “MS” button 72 to append MS data to the report 204. Thereafter, as illustrated in FIG. 18B, the application software displays a mass spectrum button report window 210 giving the user the option to select one of a variety of buttons 212-230 describing different MS functions to describe the organic compound 12. These MS functions 212-230 are well known to one of ordinary skill in the art and thus will not be described herein.

If the user selects the “Cancel” button 232, none of the MS functions will be selected and the application software will take the user back to decision 128 in FIG. 16B. If the user selects one of the MS buttons 212-230, the application software will cause another window, the mass spectrum data window 234, to pop up to allow the user to enter the chemical compound for the HRMS 236, the calculated theoretical molecular weight 238, and the found molecular weight 240. The user can either press the “Cancel” button 244, which will cause the application software to take the user back to decision 128 in FIG. 6B, or the user can press the “OK” button 242 to accept the MS data and append such to the report 204. FIG. 18D illustrates the MS data 246 in the example in FIG. 18C appended to the report 204.

FIG. 19A illustrates a user request to the application software to append CHN data to the report 204. The user places the crosshair 58 of the puck 54 over the CHN button 74 located in the buttons area 62 of the template 50. After the user selects the CHN button 74, the application software causes the CHN report window 248 to appear whereby the user can enter CHN data including the formula 250, and calculated and found C, H, N, and S information, 252-266. The user can select the “Cancel” button 270 to return back to decision 128 in FIG. 6B, or can select the “OK” button 268 to cause the application software to append the CHN data 724 to the report 204.

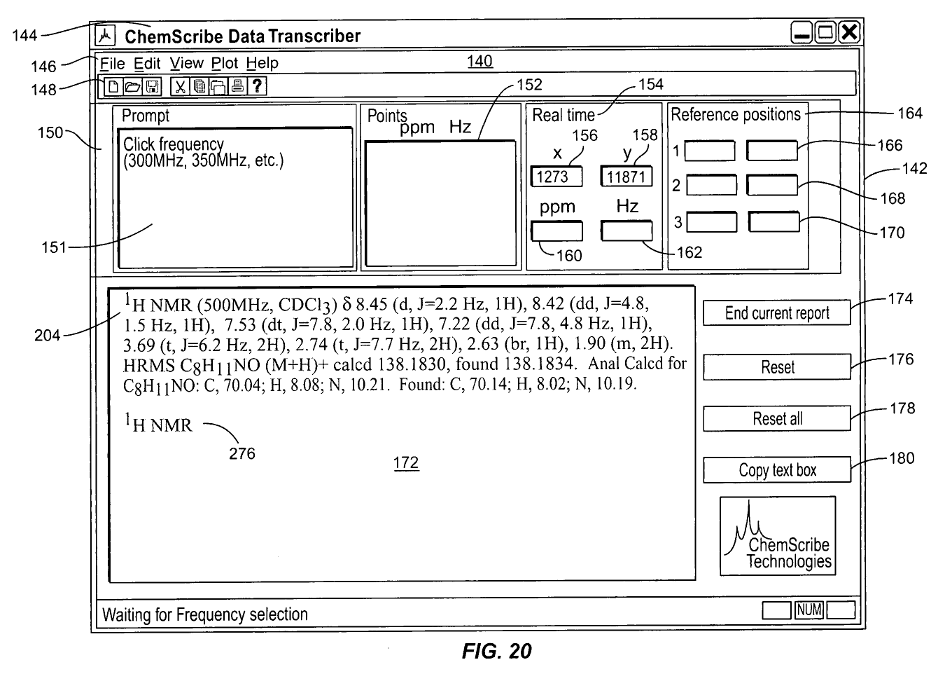

After the user is completed with the report 204, the user selects the “end current report” button 76 on the template 50 or the end current report button 174 in the user interface 140. This indicates to the application software that the report 204 is completed, after which the application software will add a period (“.”) to the end of the report 204 as illustrated in FIG. 20, and the process moves from decision 134 to step 112 in FIG. 6A. This allows the user to replace the stacked plot 42 with another and to transcribe another report 276 as illustrated in FIG. 20.

Those skilled in the art will recognize improvements and modifications to the preferred embodiments of the present invention. All such improvements and modifications are considered within the scope of the concepts disclosed herein and the claims that follow.

1. A method of transcribing nuclear magnetic resonance (NMR) spectrum graphical data from a NMR stacked plot into a textual report, comprising the steps of:
(a) receiving a coordinate point of a peak from a signal on the NMR stacked plot from a graphics tablet containing the stacked plot in which the coordinate point was selected by a pointing device coupled to a graphics tablet;
(b) converting the coordinate point of the peak into a NMR spectral position; and
(c) calculating a NMR spectral parameter from the NMR spectral position.

2. The method of claim 1, further comprising the step of outputting the calculated NMR spectral parameter into a textual report.

3. The method of claim 1, further comprising the step of receiving from the graphics tablet one or more reference points that were selected by the pointing device before performing steps (a)-(c) to calibrate the location of the stacked plot with respect to the graphics tablet.

4. The method of claim 0.1, wherein step (c) further comprises receiving from the graphics tablet, the signal type that was selected by the pointing device.

5. The method of claim 4, wherein the signal consists of a signal from the group consisting of a singlet, a multiplet, a broad singlet, a doublet, a triplet, a quartet, a quintet, a doublet of doublets, and a doublets of triplets.

6. The method of claim 2, further comprising receiving from the graphics tablet the number of protons for the signal that was selected by the pointing device after step (c).

7. The method of claim 6, further comprising appending the number of protons for the signal to the textual report.

8. The method of claim 2, further comprising receiving from the graphics tablet a request that was selected by the pointing device to append mass spectrum (MS) or CHN data to the textual report.

9. The method of claim 8, further comprising appending the MS or CHN data to the textual report.

10. The method of claim 1, wherein steps (a)-(b) are repeated for each signal in the stacked plot.

11. The method of claim 1, wherein the signal is a signal having a plurality of peaks and steps (a)-(b) are repeated for each peak within the signal to form a plurality of coordinate points corresponding to the plurality of peaks.

12. The method of claim 11., wherein step (b) is comprised of converting the plurality of peaks into a corresponding plurality of NMR spectrum positions.

13. The method of claim 12, wherein step (c) further comprises receiving from the graphics tablet the signal type that was selected by the pointing device.

14. The method of claim 13, wherein step (c) is comprised of calculating a NMR spectral parameters from the NMR spectral positions.

15. The method of claim 12, further comprising outputting the plurality of NMR spectrum positions into the textual report.

16. The method of claim 1, further comprising the step of receiving the spectrum type of the stacked plot from the graphics tablet that was selected by the pointing device.

17. The method of claim 16, further comprising outputting the calculated NMR spectral parameter into a textual report and including the spectrum type in the textual report.

18. The method of claim 1, further comprising the step of receiving from the graphics tablet the frequency of the spectrum contained on the stacked plot that was selected by the pointing device.

19. The method of claim 18, further comprising outputting the calculated NMR spectral parameter into a textual report and including the frequency of the spectrum in the textual report.

20. The method of claim 1, further comprising the step of receiving from the graphics tablet the solvent in which the organic chemical described in the spectrum on the stacked plot was dissolved that was selected by the pointing device.

21. The method of claim 20, further comprising outputting the calculated NMR spectral parameter into a textual report and including the solvent in the textual report.

22. The method of claim 1, further comprising the step of receiving from the graphics tablet the layout of the stacked plot that was selected by the pointing device.

23. The method of claim 1, further comprising the steps of:
selecting a stored geometric definition of the stacked plot based on the layout of the stacked plot; and
using the geometric definition in step (b) for converting the coordinate point of the peak into a NMR spectrum position.

24. The method of claim 1, wherein steps (a)-(c) are performed by an application software executing on a computer.

25. The method of claim 24, further comprising the step of generating a user interface under control of the application software and displaying the user interface a monitor coupled to the computer.

26 The method of claim 25, further comprising the step of prompting on the user interface to receive a coordinate point for the peak on the user interface before performing step (a).

27. The method of claim 1, further comprising the step of prompting on the user interface to receive information from the group consisting of the spectrum type of the stacked plot, the frequency of the spectrum on the stacked plot, one or more reference points from the stacked plot, the solvent in which the organic compound described on the spectrum on the stacked plot was dissolved, and the layout of the stacked plot.

28. The method of claim 27, further comprising the step of prompting on the user interface to enter the number of protons corresponding to the signal.

29. A system for transcribing nuclear magnetic resonance (NMR) spectrum graphical data from a NMR stacked plot into a textual report, comprised of:
a graphics tablet adapted to hold the NMR stacked plot;
a computer system communicatively coupled to the graphics tablet via a communications channel;
a pointing device communicatively coupled to the graphics tablet such that when the pointing device is selected, the coordinate of the location of the pointing device on the graphics tablet is communicated over the communication channel to the computer; and
said computer system adapted to:
(a) receive from the graphics tablet a coordinate point of a peak from a signal on the NMR stacked plot in which the coordinate point was selected by a pointing device coupled to a graphics tablet;
(b) convert the coordinate point of the peak into a NMR spectral position; and
(c) calculate the NMR spectral parameter from the NMR spectral position.

30. The system of claim 29, wherein the computer system is further adapted to output the calculated NMR spectral parameter into a textual report.

31. The system of claim 29, wherein the computer system receives one or more reference points from the graphics tablet that were selected by the pointing device to calibrate the location of the stacked plot with respect to the graphics tablet

32. The system of claim 29, wherein the computer system is adapted to receive the signal type from the graphics tablet that was selected by the pointing device.

33. The system of claim 32, wherein the signal type consists of a signal type from the group consisting of a singlet, a broad singlet, a doublet, a triplet, a quartet, a quintet, a doublet of doublets, and a doublet of triplets.

34. The system of claim 29, wherein said computer system is further adapted to receive from the graphics tablet the number of protons for the signal that was selected by the pointing device.

35. The system of claim 34, wherein said computer system is further adapted to:
output the calculated NMR spectral parameter into a textual report; and
append the number of protons for the signal to the textual report.

36. The system of claim 29, wherein said computer system is further adapted to:
output the calculated NMR spectral parameter into a textual report; and
receive from the graphics tablet a request that was selected by the pointing device to append mass spectrum (MS) or CHN data to the textual report

37. The system of claim 36, wherein said computer system is further adapted to append the MS or CHN data to the textual report.

38. The system of claim 29, wherein the signal is a signal having a plurality of peaks and the computer system is adapted to:
receive from the graphics tablet a plurality of coordinate points corresponding to the plurality of peaks on the NMR stacked plot in which the plurality of coordinate points were selected by a pointing device coupled to a graphics tablet;
convert the plurality of coordinate points into corresponding NMR spectrum points;
calculate the NMR spectral parameters from the NMR spectrum points; and
output the calculated NMR spectral parameters into a textual report.

39. The system of claim 38, wherein the computer system is further adapted to receive from the graphics tablet the signal type that was selected by the pointing device.

40. The system of claim 39, wherein the computer system is further adapted to:
output the calculated NMR spectral parameter into a textual report; and
include the signal type in the textual report.

41. The system of claim 29, wherein the computer system is further adapted to receive from the graphics tablet the spectrum type of the spectrum on the stacked plot that was selected by the pointing device.

42. The system of claim 41, wherein the computer system is further adapted to:
output the calculated NMR spectral parameter into a textual report; and
include the spectrum type in the textual report.

43. The system of claim 29, wherein the computer system is further adapted to receive from the graphics tablet the frequency of the spectrum on the stacked plot that was selected by the pointing device.

44. The system of claim 43, wherein the computer system is further adapted to:
output the calculated NMR spectral parameter into a textual report; and
include the frequency of the spectrum in the textual report.

45. The system of claim 29, wherein the computer system is further adapted to receive from the graphics tablet the solvent in which the organic chemical described in the spectrum on the stacked plot was dissolved that was selected by the pointing device.

46. The system of claim 45, wherein the computer system is further adapted to:
output the calculated NMR spectral parameter into a textual report; and
include the solvent in the textual report.

47. The system of claim 29, wherein the computer system is further adapted to receive from the graphics tablet the layout of the stacked plot that was selected by the pointing device.

48. The system of claim 29, wherein the computer system is further adapted to:
select a stored geometric definition of the stacked plot based on the layout of the stacked plot; and
use the geometric definition to convert the coordinate point of the peak into a NMR spectrum point.

49. The system of claim 29, wherein the computer system is further adapted to execute application software that displays a user interface on a monitor coupled to the computer system.

50. The system of claim 49, wherein the application software displays a prompt on the user interface to receive the coordinate point for the peak of the signal on the user interface.

51. The system of claim 50, wherein the application software displays a prompt on the user interface to receive information from the group consisting of the spectrum type of the spectrum on the stacked plot, the frequency of the spectrum on the stacked plot, one or more reference points from the spectrum on the stacked plot, the solvent in which the organic compound described in the spectrum on the stacked plot was dissolved, and the layout of the spectrum on the stacked plot.

52. The system of claim 50, wherein the application software displays a prompt on the user interface to enter the number of protons present in the signal.

53. A peak selection device to communicate information about nuclear magnetic resonance (NMR) spectrum graphical data from a NMR stacked plot, comprising:
a graphics tablet adapted to hold the NMR stacked plot;
a puck associated with the graphics tablet, wherein the puck comprises:
puck buttons, comprising:
an enter button; and
at least one button comprised from the group consisting of a single button, broad singlet button, a doublet button, a triplet button, a quartet button, a multiplet button, a doublet of doublet button, a quintet button, and a proton button; and
a crosshair;
said puck adapted to indicate a coordinate position of a peak from a signal in the spectrum on the stacked plot with respect to the graphics tablet when the crosshair is placed over the peak and the enter button is pressed.

54. The device of claim 53, wherein said puck is a mouse.
